(19) United States
(12) Patent Application Publication
(10) Pub. No.: US 2026/0202784 A1
(43) Pub. Date: Jul. 16, 2026

(54) IMAGE FORMING APPARATUS, IMAGE FORMING METHOD, NON-TRANSITORY RECORDING MEDIUM, AND IMAGE FORMING SYSTEM

(71) Applicant: Tomonori TAMURA, Kanagawa (JP)

(72) Inventor: Tomonori TAMURA, Kanagawa (JP)

(21) Appl. No.: 19/372,274

(22) Filed: Oct. 29, 2025

(30) Foreign Application Priority Data
Jan. 15, 2025 (JP) 2025-005595

(51) Int. Cl. G03G 15/00; G03G 21/00; G06K 15/02; G06N 5/04; G06T 7/00; H04N 1/00

(52) U.S. Cl. CPC G03G 15/5062; G03G 15/556; G03G 21/0005; G06K 15/027; G06N 5/04; G06T 7/001; H04N 1/00795; G06T 2207/30144; H04N 2201/0081

(57) ABSTRACT

An image forming apparatus includes: an image bearer to bear a toner image to be formed on a sheet; a cleaning device to collect residual toner that remains untransferred on the image bearer; an image reader to read the toner image formed on the sheet; and circuitry that identifies a type of an abnormal image based on a difference between to-be-formed image data of the toner image to be formed on the sheet and read image data of the toner image formed on the sheet and read by the image reader, and estimates a residual toner amount of the residual toner based on the abnormal image of the identified type.

### CROSS-REFERENCE TO RELATED APPLICATIONS

This patent application is based on and claims priority pursuant to 35 U.S.C. § 119(a) to Japanese Patent Application No. 2025-005595, filed on Jan. 15, 2025, in the Japan Patent Office, the entire disclosure of which is hereby incorporated by reference herein.

### BACKGROUND

### Technical Field

The present disclosure relates to an image forming apparatus, an image forming method, a non-transitory recording medium, and an image forming system.

### Related Art

Techniques related to an image forming apparatus that forms a toner image on a sheet include a technique in which an amount of toner of a chart formed on a sheet is detected with an amount-of-attached-toner detector and a toner transfer rate is estimated from the detected amount of toner of the chart to calculate an amount of residual toner.

However, it is challenging to estimate an amount of residual toner resulting from an abnormal image caused by damage to an image bearer in a toner image formed on a sheet.

### SUMMARY

The present disclosure described herein provides an image forming apparatus including an image bearer, a cleaning device, an image reader, and circuitry. The image bearer bears a toner image to be formed on a sheet. The cleaning device collects residual toner that remains untransferred on the image bearer. The image reader reads the toner image formed on the sheet. Circuitry controls an operation of the image forming apparatus. The circuitry identifies a type of an abnormal image, based on a difference between to-be-formed image data of the toner image to be formed on the sheet and read image data of the toner image formed on the sheet and read by the image reader. The circuitry estimates a residual toner amount of the residual toner based on the abnormal image of the identified type.

The present disclosure described herein provides an image forming method including with an image bearer bearing a toner image to be formed on a sheet, with a cleaning device collecting residual toner that remains untransferred on the image bearer, with an image reader reading the toner image formed on the sheet, identifying a type of an abnormal image, based on a difference between to-be-formed image data of the toner image to be formed on the sheet and read image data of the toner image formed on the sheet and read, and estimating a residual toner amount of the residual toner based on the abnormal image of the identified type.

The present disclosure described herein provides an image forming system including an image forming apparatus and an information processing apparatus. The image forming apparatus forms a toner image on a sheet. The information processing apparatus is communicatively connected to the image forming apparatus. The image forming apparatus includes an image bearer, a cleaning device, an image reader, and first circuitry. The image bearer bears the toner image. The cleaning device collects residual toner that remains untransferred on the image bearer. The image reader reads the toner image formed on the sheet. The first circuitry controls an operation of the image forming apparatus, and acquires environmental information indicating an environment inside the image forming apparatus and sheet type information of the sheet on which the toner image is to be formed. The information processing apparatus includes second circuitry. The second circuitry infers a correction parameter using a learning model from the acquired environmental information and the acquired sheet type information. The learning model is a model that receives, as input, the acquired environmental information and the acquired sheet type information and outputs the correction parameter for correcting an estimated amount of the residual toner. The estimated amount is a residual toner amount estimated from to-be-formed image data of the toner image to be formed on the sheet. The first circuitry identifies a type of an abnormal image, based on a difference between the to-be-formed image data of the toner image to be formed on the sheet and read image data of the toner image formed on the sheet and read, estimates the residual toner amount of the residual toner based on the abnormal image of the identified type, and corrects the residual toner amount of the residual toner estimated from the to-be-formed image data, using the inferred correction parameter.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic cross-sectional view of a general arrangement of an image forming apparatus according to a first embodiment;

FIG. 2 is a block diagram illustrating a hardware configuration of the image forming apparatus according to the first embodiment;

FIG. 3 is a block diagram illustrating a functional configuration of a controller included in the image forming apparatus according to the first embodiment;

FIG. 4 is a diagram illustrating an example of to-be-formed image data in the image forming apparatus according to the first embodiment;

FIG. 5 is a diagram illustrating a first example of read image data including an abnormal image obtained by the image forming apparatus according to the first embodiment;

FIG. 6 is a diagram illustrating a second example of read image data including an abnormal image obtained by the image forming apparatus according to the first embodiment;

FIG. 7 is a flowchart illustrating an operation of estimating a residual toner amount performed by the image forming apparatus according to the first embodiment;

FIG. 8 is a block diagram illustrating a functional configuration of a controller included in an image forming apparatus according to a second embodiment;

FIG. 9 is a schematic diagram of a learning model of a neuron in the image forming apparatus according to the second embodiment;

FIG. 10 is a schematic diagram of a learning model of a neural network in the image forming apparatus according to the second embodiment;

FIG. 11 is a flowchart illustrating an operation of generating the learning model performed by the image forming apparatus according to the second embodiment;

FIG. 12 is a diagram illustrating an example of a training dataset used in generation of the learning model in the image forming apparatus according to the second embodiment;

FIG. 13 is a flowchart illustrating an operation of creating abnormal image management information performed by the image forming apparatus according to the second embodiment;

FIG. 14 is a diagram illustrating an example of the abnormal image management information in the image forming apparatus according to the second embodiment;

FIG. 15 is a flowchart illustrating an operation of estimating a residual toner amount performed by the image forming apparatus according to the second embodiment;

FIG. 16 is a block diagram illustrating a functional configuration of a controller included in an image forming apparatus according to a third embodiment;

FIG. 17 is a flowchart illustrating an additional learning operation performed by the image forming apparatus according to the third embodiment;

FIG. 18 is a block diagram illustrating a functional configuration of a controller included in an image forming apparatus according to a fourth embodiment;

FIG. 19 is a schematic diagram illustrating a general arrangement of an image forming system according to a fifth embodiment;

FIG. 20 is a block diagram illustrating a hardware configuration of a server included in the image forming system according to the fifth embodiment;

FIG. 21 is a block diagram illustrating a functional configuration of a controller of an image forming apparatus included in the image forming system according to the fifth embodiment; and

FIG. 22 is a block diagram illustrating a functional configuration of the server included in the image forming system according to the fifth embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An image forming apparatus, an image forming method, a program, and an image forming system according to embodiments will be described in detail with reference to the drawings. The embodiments below merely present examples of the image forming apparatus, the image forming method, the program, and the image forming system disclosed herein and do not limit the image forming apparatus, the image forming method, the program, and image forming system to the examples below. For example, dimensions and positional relationships of members illustrated in the drawings are sometimes exaggerated to clarify the description.

In the description below, terms indicating specific directions or positions (e.g., “up”, “down”, or other terms including “up” and “down”) may be used. However, such terms are employed just for facilitating understanding of relative directions or positions in the drawings referred to. As long as a relative directional or positional relationship in drawings other than those in the present disclosure, actual products, or the like is the same as the relative directional or positional relationship indicated by terms such as “up” and “down” in the drawings referred to, the arrangement in the drawings other than those in the present disclosure, actual products, or the like is not necessarily identical to that in the drawings referred to. In the description below, identical names and reference signs indicate identical or equivalent members, and detailed description thereof is omitted as appropriate. The term “arrange” is not limited to cases of direct contact but also includes cases of indirect arrangement, for example, arrangement through another member.

### First Embodiment

### Configuration of Image Forming Apparatus According to First Embodiment General Arrangement

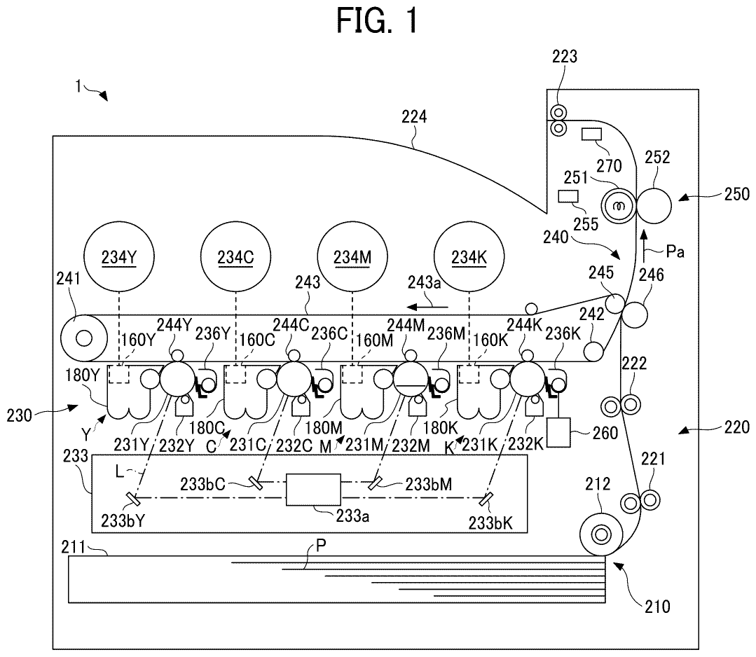

FIG. 1 is a schematic cross-sectional view of a general arrangement of an image forming apparatus 1 according to a first embodiment.

The image forming apparatus 1 illustrated in FIG. 1 is a printer that forms a toner image on a sheet P. The sheet P is, for example, a sheet of paper. The toner image refers to an image formed using toner.

Note that an image forming apparatus according to embodiments is not limited to a printer and may be any apparatus that can form a toner image on a sheet P such as a multifunction peripheral (MFP), a copier, or a facsimile apparatus. The sheet P is not limited to a sheet of paper and may be, for example, a sheet or film containing resin. The toner image encompasses a color toner image formed using yellow toner, magenta toner, cyan toner, and black toner or a monochrome toner image formed using one of yellow toner, magenta toner, cyan toner, or black toner. Hereinafter, to simplify the description, yellow, cyan, magenta, and black may be respectively denoted by Y, C, M, and K.

As illustrated in FIG. 1, the image forming apparatus 1 includes photoconductor drums 231Y, 231C, 231M, and 231K and an intermediate transfer belt 243 each of which bears a toner image. The image forming apparatus 1 also includes cleaning devices 236Y, 236C, 236M, and 236K that collect residual toner that remains untransferred on at least one of the intermediate transfer belt 243 or the respective photoconductor drums 231Y, 231C, 231M, and 231K. The image forming apparatus 1 further includes an image reader 270 that reads a toner image formed on the sheet P. The photoconductor drums 231Y, 231C, 231M, and 231K and the intermediate transfer belt 243 each correspond to an example of an image bearer to bear a toner image.

The photoconductor drum 231Y is used for image formation using Y toner. The photoconductor drum 231C is used for image formation using C toner. The photoconductor drum 231M is used for image formation using M toner. The photoconductor drum 231K is used for image formation using K toner. In the description below, any given photoconductor drum among the photoconductor drums 231Y, 231C, 231M, and 231K may be referred to as a photoconductor drum 231.

Any given cleaning device among the cleaning devices 236Y, 236C, 236M, and 236K may be referred to as a cleaning device 236.

In the example illustrated in FIG. 1, the image forming apparatus 1 includes a sheet feeding section 210 that feeds the sheet P to the image forming apparatus 1, a conveyance section 220 that conveys the sheet P fed by the sheet feeding section 210, and an image formation section 230 that forms a toner image on each photoconductor drum 231. The image forming apparatus 1 also includes a transfer section 240 that transfers the toner image formed on each photoconductor drum 231 by the image formation section 230, onto the sheet P conveyed by the conveyance section 220. The image forming apparatus 1 further includes a fixing device 250 that fixes, to the sheet P, the toner image that has been transferred onto the sheet P by the transfer section 240. The image forming apparatus 1 additionally includes an accommodating member 260 that accommodates residual toner collected by the cleaning device 236, and a temperature/humidity detector 255 that detects a temperature and a humidity at a place where the image forming apparatus 1 is installed.

The image forming apparatus 1 is an image forming apparatus of a tandem system including the photoconductor drums 231 and the intermediate transfer belt 243 as image bearers. Note that the image forming apparatus according to embodiments is not limited to the image forming apparatus of the tandem system and may be an image forming apparatus of a direct transfer system that directly transfers a formed toner image on a photoconductor drum onto a sheet P.

The sheet feeding section 210 includes a sheet feeding cassette 211 that is loaded with sheets P to be fed, and a sheet feeding roller 212 that feeds the sheets P loaded in the sheet feeding cassette 211 one by one.

The conveyance section 220 includes rollers 221 that convey the sheet P fed by the sheet feeding roller 212, toward the transfer section 240. The conveyance section 220 includes a pair of timing rollers 222 that stands by while sandwiching the leading end portion of the sheet P conveyed by the rollers 221 and sends out the sheet P to the transfer section 240 at a predetermined timing. The conveyance section 220 further includes sheet ejection rollers 223 that eject the sheet P having a color toner image fixed thereon to a sheet ejection tray 224.

The image formation section 230 includes an image forming unit Y that uses a developer including Y toner in image formation, an image forming unit C that uses a developer including C toner, an image forming unit M that uses a developer including M toner, an image forming unit K that uses a developer including K toner, and an exposure device 233.

The image forming unit Y, the image forming unit C, the image forming unit M, and the image forming unit K are arranged side by side at predetermined intervals in a direction intersecting an up-down direction in a cross-section including the photoconductor drums 231.

The exposure device 233 is arranged below the image forming unit Y, the image forming unit C, the image forming unit M, and the image forming unit K. The developer includes toner and a carrier.

The four image forming units Y, C, M, and K have substantially the same mechanical configuration except that the developers used thereby are different.

The image forming units Y, C, M, and K each include the photoconductor drum 231 that is rotatable clockwise and on which an electrostatic latent image and a toner image are formed. The image forming unit Y, C, M, and K respectively include chargers 232Y, 232C, 232M, and 232K each of which uniformly charges the surface of the corresponding photoconductor drum 231. The image forming unit Y, C, M, and K respectively include developing devices 180Y, 180C, 180M, and 180K each of which develops the electrostatic latent image that has been formed on the surface of the corresponding photoconductor drum 231 by the exposure device 233, into a toner image using toner of the corresponding color. The image forming unit Y, C, M, and K each include the cleaning device 236 that removes toner remaining on the surface of the corresponding photoconductor drum 231.

The image forming units Y, C, M, and K respectively include toner cartridges 234Y, 234C, 234M, and 234K that accommodate toner of respective colors, and sub-hoppers 160Y, 160C, 160M, and 160K that replenish toner supplied from the toner cartridges 234Y, 234C, 234M, and 234K, respectively.

The toner of the respective colors contained in the toner cartridges 234Y, 234C, 234M, and 234K are ejected by a conveying screw and supplied to the sub-hoppers 160Y, 160C, 160M, and 160K through respective supply tubes, respectively. The sub-hoppers 160Y, 160C, 160M, and 160K convey the toner of the respective colors supplied from the toner cartridges 234Y, 234C, 234M, and 234K, to the developing devices 180Y, 180C, 180M, and 180K, respectively. The developing devices 180Y, 180C, 180M, and 180K respectively develop the electrostatic latent image formed on the respective photoconductor drums 231, using toner supplied from the sub-hoppers 160Y, 160C, 160M, and 160K.

In the description below, any given image forming unit among the image forming units Y, C, M, and K is referred to as an image forming unit. Any given charger among the chargers 232Y, 232C, 232M, and 232K may be referred to as a charger 232. Any given toner cartridge among the toner cartridges 234Y, 234C, 234M, and 234K may be referred to as a toner cartridge 234. Any sub-hopper among the sub-hoppers 160Y, 160C, 160M, and 160K may be referred to as a sub-hopper 160. Any given developing device among the developing devices 180Y, 180C, 180M, and 180K may be referred to as a developing device 180.

Examples of the photoconductor drum 231 include, but are not limited to, inorganic photoconductor drums such as an amorphous silicon photoconductor drum and a selenium photoconductor drum, and organic photoconductor drums such as a polysilane photoconductor drum and a phthalopolymethine photoconductor drum. Among the above-cited examples, the amorphous silicon photoconductor drum is preferable from the standpoint of long service life.

Examples of the charger 232 include, but are not limited to, a known contact charger including a conductive or semiconductive roller, a brush, a film, and a rubber blade and a non-contact charger using corona discharge such as a corotron or scorotron. Preferably, the charger 232 is arranged in contact with or not in contact with the photoconductor drum 231 and applies superimposition of a direct-current (DC) and alternating-current (AC) voltages to charge the outer surface of the photoconductor drum 231. The charger 232 includes a charge roller arranged not in contact with and in proximity to the photoconductor drum 231 through a gap tape. Preferably, the charger 232 applies superimposition of DC and AC voltages to the charge roller to charge the surface of the photoconductor drum 231.

The exposure device 233 irradiates the photoconductor drum 231 with a laser beam L that is emitted from a light source 233a based on image information and reflected by a polygon mirror 233b (233bY, 233bC, 233bM, or 233bK) that is driven to rotate by a motor. The exposure device 233 is any one of various exposure devices with a copying optical system, a rod lens array system, a laser optical system, and a liquid crystal shutter optical system. The exposure device 233 is not limited to a particular type and may be any device that can expose the surface of the photoconductor drum 231 charged by the charger 232 with light of an image to be formed. A rear-side exposure method may be adopted in which the photoconductor drum 231 is exposed with light in the form of the image from the inner surface side.

The developing device 180 is preferably a developing device that accommodates a developer and applies the developer to an electrostatic latent image in a contact or non-contact manner. The developing device 180 is more preferably a developing device with a developer-accommodating container. The developing device 180 is not limited to a particular type and may be any device that can develop an electrostatic latent image using a developer. The developing device 180 may be a developing device for a single color, or may be a developing device for multiple colors.

The cleaning device 236 preferably includes a cleaner such as a magnetic brush cleaner, an electrostatic brush cleaner, a magnetic roller cleaner, a blade cleaner, a brush cleaner, or a web cleaner. The cleaning device 236 is not limited to a specific type and may be any member that can collect residual toner that remains untransferred on the photoconductor drum 231 and the intermediate transfer belt 243. In the example illustrated in FIG. 1, the cleaning device 236 is arranged at a position where the residual toner on the photoconductor drum 231 is collected. The cleaning device 236 may be arranged at a position where the residual toner on the intermediate transfer belt 243 is collected. The photoconductor drum 231 or the intermediate transfer belt 243 from which toner is removed by the cleaning device 236 is discharged, so that a residual potential is removed. As a result, a sequence of an image forming process performed on the photoconductor drum 231 ends. The residual toner collected by the cleaning device 236 is accommodated by the accommodating member 260.

The transfer section 240 includes a drive roller 241, a driven roller 242, and the intermediate transfer belt 243 that is rotatable counterclockwise in accordance with the driving of the drive roller 241. The transfer section 240 also includes primary transfer rollers 244Y, 244C, 244M, and 244K disposed opposite the respective photoconductor drums 231 with the intermediate transfer belt 243 therebetween. The transfer section 240 further includes a secondary opposing roller 245 and a secondary transfer roller 246 that are opposite each other with the intermediate transfer belt 243 therebetween at a position where the toner image is transferred onto the sheet P.

Any given primary transfer roller among the primary transfer rollers 244Y, 244C, 244M, and 244K may be referred to as a primary transfer roller 244. A primary transfer bias having a polarity opposite to the polarity of toner is applied to the primary transfer roller 244. The intermediate transfer belt 243 is sandwiched between the primary transfer roller 244 and the photoconductor drum 231 to form a primary transfer nip. This allows a toner image of each color formed on the surface of the corresponding photoconductor drum 231 to be transferred to the intermediate transfer belt 243 (primary transfer). As the intermediate transfer belt 243 rotates in a direction of an arrow 243a, the toner images of respective colors formed on the photoconductor drums 231 are sequentially transferred onto the intermediate transfer belt 243, so that a color toner image is formed.

A secondary transfer bias is applied to the secondary transfer roller 246 of the transfer section 240. This allows the color toner image formed on the intermediate transfer belt 243 to be transferred onto the sheet P sandwiched between the secondary transfer roller 246 and the secondary opposing roller 245 at a secondary transfer nip (secondary transfer).

The fixing device 250 includes a fixing belt 251 that has a heater therein and heats the sheet P, and a pressure roller 252 that applies a pressure to and rotate the fixing belt 251 to form a nip. The fixing device 250 applies heat and pressure to the color toner image on the sheet P with the fixing belt 251 and the pressure roller 252 to fix the color toner image on the sheet P. The sheet P having the color toner image fixed thereon is ejected to the sheet ejection tray 224 by the sheet ejection rollers 223. After the sheet P having the color toner image fixed thereon is ejected to the sheet ejection tray 224, a sequence of an image formation process is completed.

The temperature/humidity detector 255 detects a temperature and a humidity inside or outside the image forming apparatus 1 at a place where the image forming apparatus 1 is installed. The temperature/humidity detector 255 includes temperature/humidity sensor elements and a processing circuit that processes detection results obtained by the sensor elements. The temperature/humidity detector 255 may use any one of various detection schemes such as an electrostatic capacitance type or an electrical resistance type. When the fixing device 250 includes a temperature/humidity detector for use in a fixing operation, the temperature/humidity detector may be used as the temperature/humidity detector 255.

The image reader 270 may be disposed at a given position between the secondary transfer roller 246 and the sheet ejection rollers 223. In the example illustrated in FIG. 1, the image reader 270 is arranged downstream of the fixing device 250 in a conveyance direction Pa of the sheet P. The image reader 270 reads the toner image fixed on the sheet P to obtain read image data. In the example illustrated in FIG. 1, the image reader 270 reads the toner image formed on one side of the sheet P being conveyed. The image forming apparatus 1 may include a plurality of image readers 270 arranged to read respective sides of the sheet P, and simultaneously read toner images formed on the respective sides of the sheet P being conveyed.

The image reader 270 is, for example, a charge coupled device (CCD) line sensor in which a plurality of pixels are arranged in a one-dimensional array. The plurality of pixels each output an electric signal according to intensity of received light. The plurality of pixels of the image reader 270 are arranged to read the entire width of the sheet P in a direction perpendicular to the conveyance direction Pa of the sheet P. The direction in which the plurality of pixels are arranged is a direction intersecting the conveyance direction Pa of the sheet P.

The image reader 270 includes a pixel array that receives red light (R), a pixel array that receives green light (G), and a pixel array that receives blue light (B). The image reader 270 outputs, with the pixel arrays of the respective colors, electric signals according to intensity of reflected light from the toner image formed on the sheet P. The image reader 270 may include a light source that irradiates the sheet P with light. The irradiation of the sheet P with light from the light source can ensure the brightness when the image reader 270 performs reading. The image reader 270 may include, as the pixels, complementary metal-oxide-semiconductor (CMOS) array or photodiode (PD) array instead of the CCD array.

### Hardware Configuration

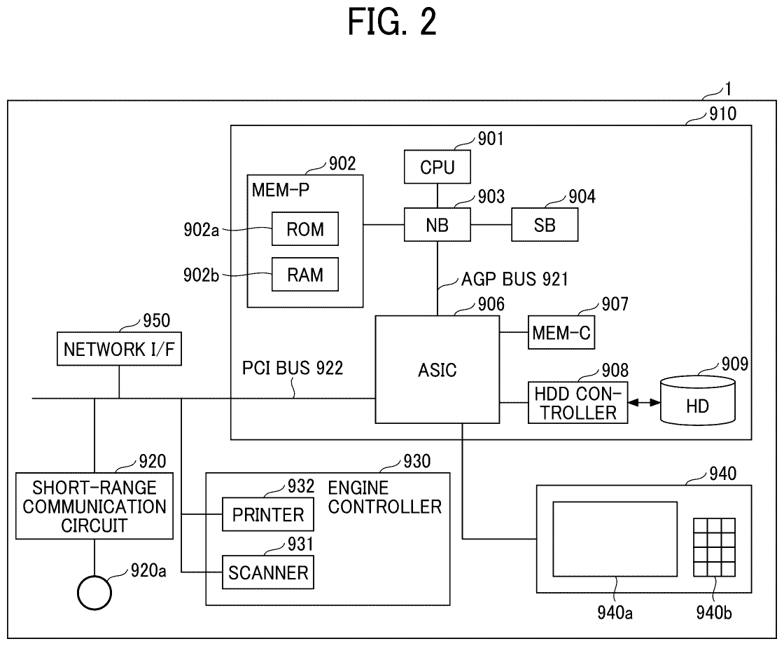

FIG. 2 is a block diagram illustrating an example of a hardware configuration of the image forming apparatus 1. The image forming apparatus 1 includes a controller 910, a short-range communication circuit 920, an engine controller 930, a control panel 940, and a network interface (I/F) 950.

The controller 910 is an example of a controller that controls an operation of the image forming apparatus 1. The controller 910 includes a central processing unit (CPU) 901 as a main processor of a computer, a system memory (MEM-P) 902, a northbridge (NB) 903, and a southbridge (SB) 904.

The controller 910 also includes an application specific integrated circuit (ASIC) 906, a local memory (MEM-C) 907 as a storage, a hard disk drive (HDD) controller 908, and a hard disk (HD) 909 as a storage. The NB 903 and the ASIC 906 are connected to each other by an Accelerated Graphics Port (AGP) bus 921.

The CPU 901 is a processor that reads a program or data stored in a read-only memory (ROM) 902a to a random access memory (RAM) 902b and executes a process to implement functions of the image forming apparatus 1. The processor is not limited to the CPU 901, and may be a graphics processing unit (GPU), an ASIC, a field programmable gate array (FPGA). The NB 903 is a bridge for connecting the CPU 901 to the MEM-P 902, the SB 904, and the AGP bus 921. The NB 903 includes a memory controller that controls reading from or writing to the MEM-P 902, a Peripheral Component Interconnect (PCI) master, and an AGP target.

The MEM-P 902 includes the ROM 902a serving as a memory for storing a program or data for implementing various functions of the controller 910. The MEM-P 902 further includes the RAM 902b serving as a memory for deploying a program or data and as a drawing memory for memory printing. In one example, the program stored in the RAM 902b may be provided by being recorded in a computer-readable recording medium such as a compact disk read-only memory (CD-ROM), a compact disk recordable (CD-R), or a digital versatile disk (DVD) in a file of an installable format or an executable format.

The SB 904 is a bridge that connects the NB 903 to a PCI device or a peripheral device. The ASIC 906 is an integrated circuit (IC) dedicated to an image processing use and including hardware elements for image processing. The ASIC 906 has a role of a bridge that connects the AGP bus 921, a PCI bus 922, the HDD controller 908, and the MEM-C 907 to each other. The ASIC 906 includes a PCI target, an AGP master, an arbiter (ARB) as a core element of the ASIC 906, a memory controller to control the MEM-C 907, a plurality of direct memory access controllers (DMACs), and a PCI unit. The DMACs perform rotation of image data with a hardware logic. The PCI unit transfers data between a scanner 931 and a printer 932 through the PCI bus 922. The ASIC 906 may be connected to a Universal Serial Bus (USB) interface or an Institute of Electrical and Electronics Engineers 1394 (IEEE 1394) interface.

The MEM-C 907 is a local memory used as a buffer for image data to be copied and a code buffer. The HD 909 is a storage that stores image data, font data for printing, and form data. The HDD controller 908 controls reading of data from or writing of data to the HD 909 under control of the CPU 901. The AGP bus 921 is a bus interface for a graphics accelerator card that is devised for accelerating processing of graphics. The AGP bus 921 directly accesses the MEM-P 902 with high throughput to accelerate the graphics accelerator card.

The short-range communication circuit 920 includes an antenna 920a. The short-range communication circuit 920 is a communication circuit that is compliant with Near Field Communication (NFC) or Bluetooth®.

The engine controller 930 includes the scanner 931 and the printer 932. The control panel 940 includes a panel display 940a such as a touch panel, and an operation panel 940b. The panel display 940a displays a screen of current setting values, a selection screen, and so on and receives input from an operator. The operation panel 940b includes, for example, numeral buttons that receive setting values of image forming conditions such as color density setting conditions and a start button that receives a copy start instruction. The controller 910 controls the entire image forming apparatus 1 and controls, for example, rendering, communication, and input from the control panel 940. The scanner 931 or the printer 932 includes, for example, an image processor for error diffusion, or gamma conversion.

An application switch button of the control panel 940 causes the image forming apparatus 1 to sequentially switch among a document server function, a copier function, a printer function, and a facsimile function. When the document server function is selected, the image forming apparatus 1 enters a document server mode. When the copier function is selected, the image forming apparatus 1 enters a copier mode. When the printer function is selected, the image forming apparatus 1 enters a printer mode. When the facsimile function is selected, the image forming apparatus 1 enters a facsimile mode.

The network I/F 950 is an interface that enables data communication via a communication network 100 (see FIG. 19). The short-range communication circuit 920 and the network I/F 950 are electrically connected to the ASIC 906 through the PCI bus 922.

### Functional Configuration

FIG. 3 is a block diagram illustrating a functional configuration of the controller 910. The controller 910 includes an input unit 10, a storage unit 11, a first estimation unit 12, and an output unit 13.

Functions of the input unit 10 and the output unit 13 are implemented by the network I/F 950 and the engine controller 930, for example. The functions of the input unit 10 and the output unit 13 may be implemented by an electronic circuit such as the CPU 901 executing instruction code stored in a memory such as the ROM 902a or an electronic circuit whose circuitry is designed for a specific purpose executing various processes, for example. Functions of the storage unit 11 are implemented by the HD 909, for example. Functions of the first estimation unit 12 are implemented by an electronic circuit such as the CPU 901 executing instruction code stored in a memory such as the ROM 902a or an electronic circuit whose circuitry is designed for a specific purpose executing various processes, for example. Part of the functions of the first estimation unit 12 may be implemented by one or more devices or apparatuses other than the controller 910. Part of the functions of the first estimation unit 12 may be implemented through distributed processing by the controller 910 and one or more devices or apparatuses other than the controller 910.

The input unit 10 controls communication with an apparatus or device other than the controller 910 to receive information or data from the apparatus or device other than the controller 910. The input unit 10 may control the communication with the apparatus or device other than the controller 910 via a network such as Internet or a local area network (LAN).

The storage unit 11 stores to-be-formed image data 111 based on which a toner image is to be formed on the sheet P. The to-be-formed image data 111 is sent from a user of the image forming apparatus 1 and received via the input unit 10. The storage unit 11 also stores read image data 112 of the toner image that has been formed on the sheet P and read by the image reader 270. The storage unit 11 receives the read image data 112 via the input unit 10.

The first estimation unit 12 acquires the to-be-formed image data 111 and the read image data 112 with reference to the storage unit 11. The first estimation unit 12 identifies a type of an abnormal image, based on a difference between the to-be-formed image data 111 and the read image data 112, and estimates a residual toner amount of residual toner resulting from the abnormal image of the identified type. For example, the first estimation unit 12 uses a calculation method corresponding to the identified type of the abnormal image to estimate the residual toner amount of the residual toner resulting from the abnormal image of the identified type.

The first estimation unit 12 also calculates a toner amount A calculated from the to-be-formed image data 111 (described later) and a toner amount B calculated from a difference between the toner amount of the to-be-formed image data 111 and the toner amount of the read image data 112.

The first estimation unit 12 will be described in more detail. The first estimation unit 12 calculates the reference toner amount A of residual toner on each of the photoconductor drum 231 and the intermediate transfer belt 243, based on the to-be-formed image data 111, information on a transfer rate from the photoconductor drum 231 to the intermediate transfer belt 243, and information on a transfer rate from the photoconductor drum 231 to the sheet P. Specifically, the toner amount A is calculated by multiplying a toner amount used for image formation of the to-be-formed image data 111 by “1−transfer rate”. When the to-be-formed image data 111 is represented by YMCK and the read image data 112 is represented by RGB, the to-be-formed image data 111 or the read image data 112 is subjected to image conversion to have the color space of the other to allow execution of an image difference calculation.

The first estimation unit 12 determines a difference between the toner amount of the read image data 112 and the toner amount to be used for the to-be-formed image data 111 to calculate the toner amount B. The first estimation unit 12 compares the to-be-formed image data 111 with the read image data 112. When an image is present in the to-be-formed image data 111 but is absent in the read image data 112, the first estimation unit 12 adds a toner amount used for the image to a residual toner amount because of a transfer failure. When an image is absent in the to-be-formed image data 111 but is present in the read image data 112 and the image is irregular in the conveyance direction Pa of the sheet P, the first estimation unit 12 does not add the toner amount used for the image to the residual toner amount.

On the other hand, when a vertical streak image extending in the conveyance direction Pa of the sheet P is absent in the to-be-formed image data 111 but is present in the read image data 112, the first estimation unit 12 determines that the vertical streak image is the abnormal image. The first estimation unit 12 adds a toner amount D to the residual toner amount. The toner amount D is obtained by multiplying a rotational distance of the photoconductor drum 231 by the width of the vertical streak image. The rotational distance of the photoconductor drum 231 is obtained by multiplying the circumferential length of the photoconductor drum 231 by the number of rotations of the photoconductor drum 231.

In the image forming apparatus 1, deterioration of the photoconductor drum 231 may cause so-called scumming, in which toner adheres to an image-data-free area on an outer surface of the photoconductor drum 231. The first estimation unit 12 can estimate a toner amount C corresponding to such scumming.

The first estimation unit 12 performs the above-described addition operations to successfully estimate the residual toner amount. The first estimation unit 12 can output the estimation result of the residual toner amount to the apparatus or device other than the controller 910 via the output unit 13.

The output unit 13 controls communication with the apparatus or device other than the controller 910 to output information or data to the apparatus or device other than the controller 910. The output unit 13 may control the communication with the apparatus or device other than the controller 910 via a network such as the Internet or a local area network (LAN).

### Examples of Read Image Data Including Abnormal Image

### First Example

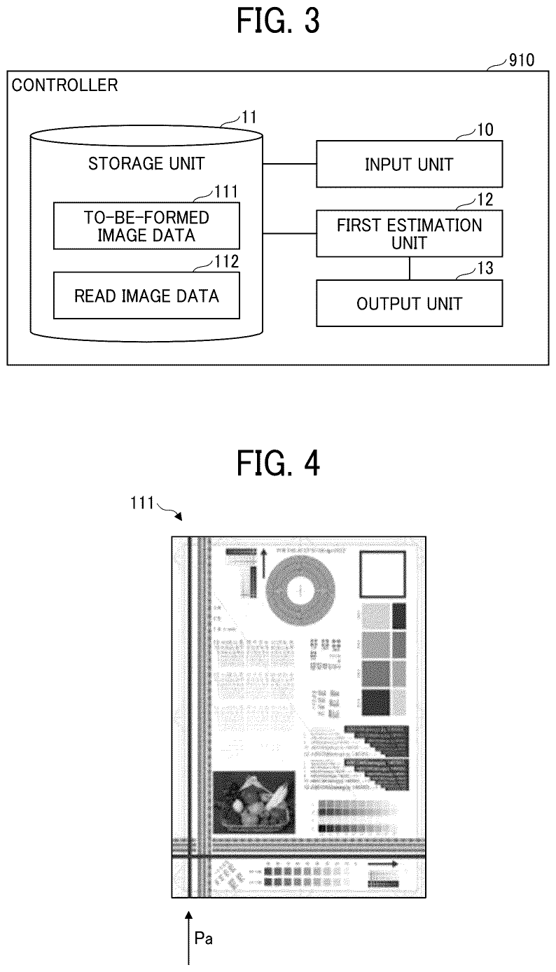

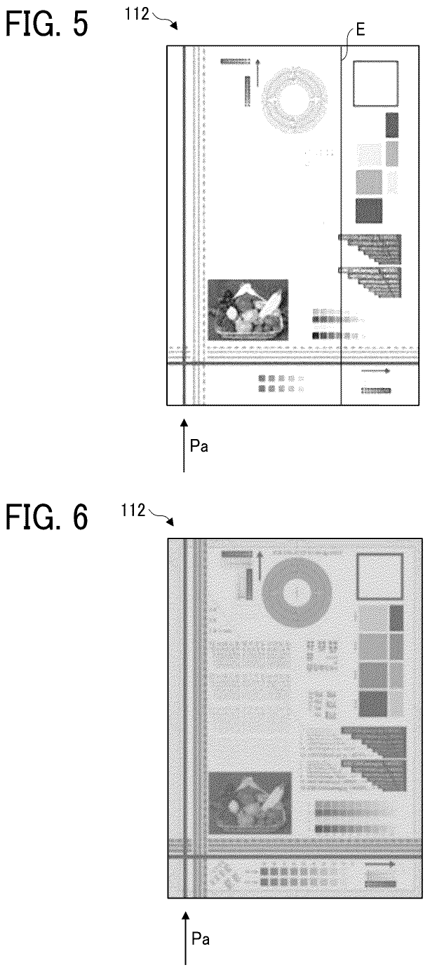

A first example of the read image data 112 including an abnormal image will be described with reference to FIGS. 4 and 5. FIG. 4 is a diagram illustrating an example of the to-be-formed image data 111 in the image forming apparatus 1. FIG. 5 is a diagram illustrating a first example of the read image data 112 including an abnormal image in the image forming apparatus 1.

The comparison of the to-be-formed image data 111 illustrated in FIG. 4 with the read image data 112 illustrated in FIG. 5 indicates that only the read image data 112 includes a vertical streak image E extending in the conveyance direction Pa of the sheet P. The vertical streak image E is an example of an abnormal image. The first estimation unit 12 determines that the vertical streak image E is the abnormal image. According to a method for calculating the residual toner amount corresponding to the vertical streak image E, the first estimation unit 12 adds the toner amount obtained by multiplying the rotational distance of the photoconductor drum 231 by the width of the vertical streak image E, to the residual toner amount. In this case, the residual toner on the photoconductor drum 231 is transferred to the sheet P. The residual toner remains also in an area on the photoconductor drum 231 corresponding to an area beyond the sheet P. The residual toner remaining in the area on the photoconductor drum 231 corresponding to the area beyond the sheet P is collected by the cleaning device 236 while the photoconductor drum 231 is rotating. The first estimation unit 12 adds the toner amount obtained by multiplying the rotational distance of the photoconductor drum 231 by the width of the vertical streak image E to the residual toner amount. This enables accurate estimation of the residual toner amount of the residual toner resulting from the vertical streak image E.

### Second Example

FIG. 6 is a diagram illustrating a second example of the read image data 112 including an abnormal image in the image forming apparatus 1. The read image data 112 illustrated in FIG. 6 is grayish as a whole as compared with the to-be-formed image data 111 illustrated in FIG. 4. The to-be-formed image data 111 illustrated in FIG. 4 becoming grayish as a whole corresponds to an example of the abnormal image. The cause of becoming grayish as a whole is scumming due to deterioration of the photoconductor drum 231. According to a method for calculating the toner amount C corresponding to such an abnormal image (scumming), the first estimation unit 12 adds the toner amount obtained by multiplying differential image data between the to-be-formed image data 111 and the read image data 112 by (1−transfer rate), to the residual toner amount. The toner amount obtained by multiplying the differential image data between the to-be-formed image data 111 and the read image data 112 by (1−transfer rate) is added to the residual toner amount.

### Operation of Image Forming Apparatus According to First Embodiment

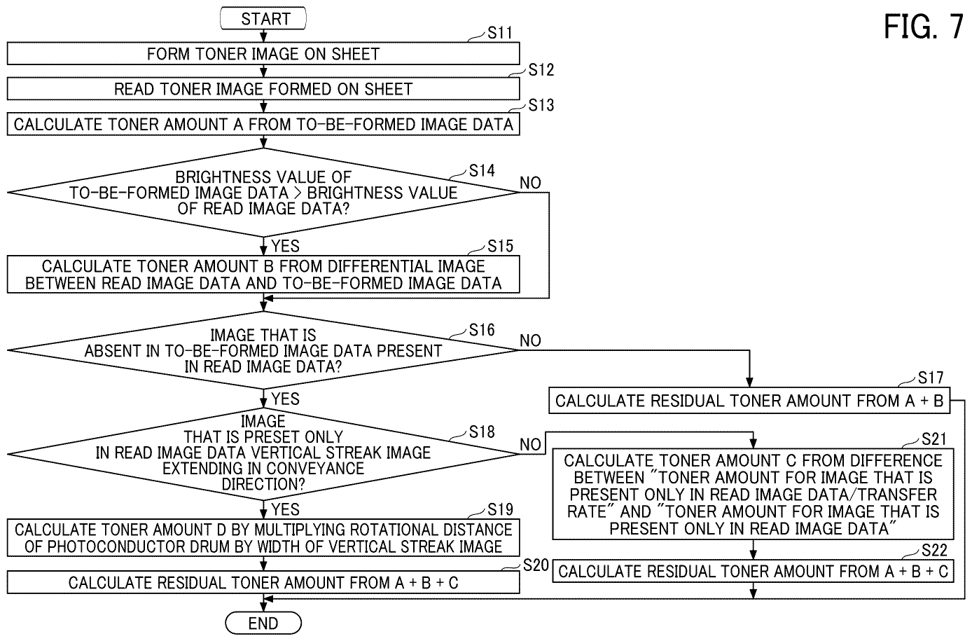

An operation of the image forming apparatus 1 according to the first embodiment will be described with reference to FIG. 7. FIG. 7 is a flowchart illustrating an operation of estimating a residual toner amount performed by the image forming apparatus 1. For example, the image forming apparatus 1 starts the operation in FIG. 7 in response to reception of the to-be-formed image data 111 from the image forming apparatus 1, which triggers the operation of FIG. 7.

In step S11, the image forming apparatus 1 forms a toner image on the sheet P based on the received to-be-formed image data 111.

In step S12, the image forming apparatus 1 reads, with the image reader 270, the toner image formed on the sheet P. Consequently, the image forming apparatus 1 obtains the read image data 112 of the toner image. At this time, the image forming apparatus 1 identifies the position of the to-be-formed image data 111 with respect to an origin that is an intersection of a side at a downstream end of the sheet P in the conveyance direction Pa and a straight line connecting the downstream end and an upstream end of the sheet P in the conveyance direction Pa.

In step S13, the image forming apparatus 1 calculates, with the first estimation unit 12, the toner amount A, which is a reference residual toner amount, based on the to-be-formed image data 111. The toner amount A is calculated by multiplying a toner amount used for image formation of the to-be-formed image data 111 by “1−transfer rate”.

In step S14, the image forming apparatus 1 determines, with the first estimation unit 12, whether a brightness value of the to-be-formed image data 111 is greater than a brightness value of the read image data 112. For example, the first estimation unit 12 compares a brightness value of an image formation area of the to-be-formed image data 111 with a brightness value of an image in the corresponding area of the read image data 112. As a result of the comparison, when the read image data 112 has a smaller brightness value, the first estimation unit 12 determines that residual toner corresponding to a difference in brightness value has been collected, and sets a toner amount corresponding to the difference in brightness value as the toner amount B. The image forming apparatus 1 has the brightness values of the read image data 112 and the to-be-formed image data 111 in advance. This allows the image forming apparatus 1 to grasp the toner amount adhered to the sheet P from the read image data 112.

If it is determined in step S14 that the brightness value of the to-be-formed image data 111 is greater than the brightness value of the read image data 112 (YES in step S14), the image forming apparatus 1 performs step S15. In step S15, the image forming apparatus 1 calculates, with the first estimation unit 12, the toner amount B from a differential image between the read image data 112 and the to-be-formed image data 111. On the other hand, if it is determined in step S14 that the brightness value of the to-be-formed image data 111 is not greater than the brightness value of the read image data 112 (NO in step S14), the image forming apparatus 1 causes the operation to proceed to step S16.

In step S16, the image forming apparatus 1 determines whether an image that is absent in the to-be-formed image data 111 is present in the read image data 112. If it is determined in step S16 that an image that is absent in the to-be-formed image data 111 is absent in the read image data 112 (NO in step S16), the image forming apparatus 1 performs step S17. In step S17, the image forming apparatus 1 calculates, with the first estimation unit 12, the residual toner amount from the sum of the toner amount A and the toner amount B, and sets the result as an estimation result of the residual toner amount. The image forming apparatus 1 then ends the operation.

On the other hand, if it is determined in step S16 that an image that is absent in the to-be-formed image data 111 is present in the read image data 112 (YES in step S16), the image forming apparatus 1 performs step S18. In step S18, the image forming apparatus 1 determines whether the image that is present only in the read image data 112 is the vertical streak image E extending in the conveyance direction Pa.

If it is determined in step S18 that the image that is present only in the read image data 112 is the vertical streak image E (YES in step S18), the image forming apparatus 1 performs step S19. The type of the abnormal image is identified in accordance with the presence or absence of the vertical streak image E in step S18. In step S19, the image forming apparatus 1 calculates, with the first estimation unit 12, the toner amount D by multiplying a rotational distance of the photoconductor drum 231 by the width of the vertical streak image E.

In step S20, the image forming apparatus 1 calculates, with the first estimation unit 12, the residual toner amount from the sum of the toner amount A, the toner amount B, and the toner amount D, and sets the result as an estimation result of the residual toner amount. The image forming apparatus 1 then ends the operation.

On the other hand, if it is determined in step S18 that the image that is present only in the read image data 112 is not the vertical streak image E (NO in step S18), the image forming apparatus 1 performs step S21. In step S21, the image forming apparatus 1 calculates, with the first estimation unit 12, the toner amount C by subtracting the “toner amount for the image that is present only in the read image data” from the “toner amount for the image that is present only in the read image data/transfer rate”. That is, in the case of NO in step S18, the image that is absent in the to-be-formed image data 111 but is present in the read image data 112 is possibly an image of so-called scumming, in which toner adheres to an image-data-free area on the outer surface of the photoconductor drum 231 due to deterioration of the photoconductor drum 231 as described above. Thus, the image forming apparatus 1 calculates the toner amount C of toner remaining on the photoconductor drum 231 because of such an abnormal image.

In step S22, the image forming apparatus 1 calculates, with the first estimation unit 12, the residual toner amount from the sum of the toner amount A, the toner amount B, and the toner amount C, and sets the result as an estimation result of the residual toner amount. The image forming apparatus 1 then ends the operation.

In the above-described manner, the image forming apparatus 1 can estimate the residual toner amount.

In the image forming apparatus 1, the first estimation unit 12 identifies a type of an abnormal image, based on a difference between the to-be-formed image data 111 and the read image data 112, and uses a calculation method corresponding to the identified type of the abnormal image to estimate a residual toner amount of residual toner resulting from the abnormal image of the identified type. This allows the image forming apparatus 1 to calculate the residual toner amount of residual toner resulting from the type of an abnormal image in accordance with the type of the abnormal image, and estimate the residual toner amount in a more detailed manner. This can consequently increase the estimation accuracy of the amount of residual toner accommodated in the accommodating member 260.

The high estimation accuracy of the amount of residual toner accommodated in the accommodating member 260 allows the image forming apparatus 1 to appropriately manage the replacement timing of the accommodating member 260. For example, the image forming apparatus 1 can prompt a service person or administrator of the image forming apparatus 1 to replace the accommodating member 260 at an appropriate timing. The image forming apparatus 1 can also reduce the unnecessary cost of replacing the accommodating member 260 that has not become full with the collected residual toner. The image forming apparatus 1 can further reduce the circumstance of leakage from the accommodating member 260 that has become full with the collected residual toner making the image forming apparatus 1 dirty.

### Second Embodiment

An image forming apparatus according to a second embodiment will be described next. In the description below, names and reference signs similar to those in the embodiment described above denote like or equivalent components, and a detailed description thereof may be omitted as appropriate. The same applies to embodiments described later.

FIG. 8 is a block diagram illustrating a functional configuration of a controller 910a included in the image forming apparatus 1 according to the present embodiment.

The controller 910a includes an information acquisition unit 14 that acquires environmental information 113 inside the image forming apparatus 1 and sheet type information 114 of the sheet P on which a toner image is formed. The controller 910a includes an inference unit 15 that infers a correction parameter using a learning model LM from the environmental information 113 and the sheet type information 114 of the sheet P acquired by the information acquisition unit 14. The learning model LM receives, as input, the environmental information 113 and the sheet type information 114 of the sheet P acquired by the information acquisition unit 14, and outputs the correction parameter for correcting an estimated amount of the residual toner amount estimated from the to-be-formed image data 111. The first estimation unit 12 corrects the residual toner amount estimated from the to-be-formed image data 111, using the correction parameter inferred by the inference unit 15. This is the difference between the controller 910a and the controller 910 included in the image forming apparatus 1 according to the first embodiment. In other words, the controller 910a differs from the controller 910 in that the controller 910a estimates the residual toner amount using artificial intelligence (AI) technology.

Functions of the information acquisition unit 14 are implemented by the HDD controller 908, for example. Functions of the inference unit 15 are implemented by an electronic circuit such as the CPU 901 executing instruction code stored in a memory such as the ROM 902a or an electronic circuit whose circuitry is designed for a specific purpose executing various processes, for example. Part of the functions of the inference unit 15 may be implemented by a device or apparatus other than the controller 910a or through distributed processing by the controller 910a and one or more devices or apparatuses other than the controller 910a.

In the example illustrated in FIG. 8, the storage unit 11 receives, as input, information on the temperature and the humidity detected by the temperature/humidity detector 255 via the input unit 10, and stores the information indicating the environment inside the image forming apparatus 1 as the environmental information 113. The storage unit 11 also receives, as input, the sheet type information 114 of the sheet P via the input unit 10, and stores the sheet type information 114. This allows the information acquisition unit 14 to acquire the environmental information 113 and the sheet type information 114 of the sheet P with reference to the storage unit 11. Note that the information acquisition unit 14 may directly acquire the environmental information 113 and the sheet type information 114 of the sheet P from the input unit 10 rather than from the storage unit 11.

The inference unit 15 includes a machine learning unit 151 that generates the learning model LM, which receives, as input, the environmental information 113 and the sheet type information 114 of the sheet P and outputs the correction parameter for correcting the estimated amount of the residual toner amount estimated from the to-be-formed image data 111. The machine learning unit 151 includes a storage unit that stores the generated learning model LM.

The inference unit 15 infers the correction parameter while using the trained learning model or performing machine learning. Machine learning is a technology that allows a computer to acquire a human-like learning ability. Machine learning refers to a technology in which a computer autonomously generates an algorithm for determination such as data identification from training data loaded in advance and applies the generated algorithm to new data to make a prediction. The machine learning method may be any of supervised learning, unsupervised learning, semi-supervised learning, reinforcement learning, and deep learning, or any combination of these learning methods. That is, any machine learning method may be used.

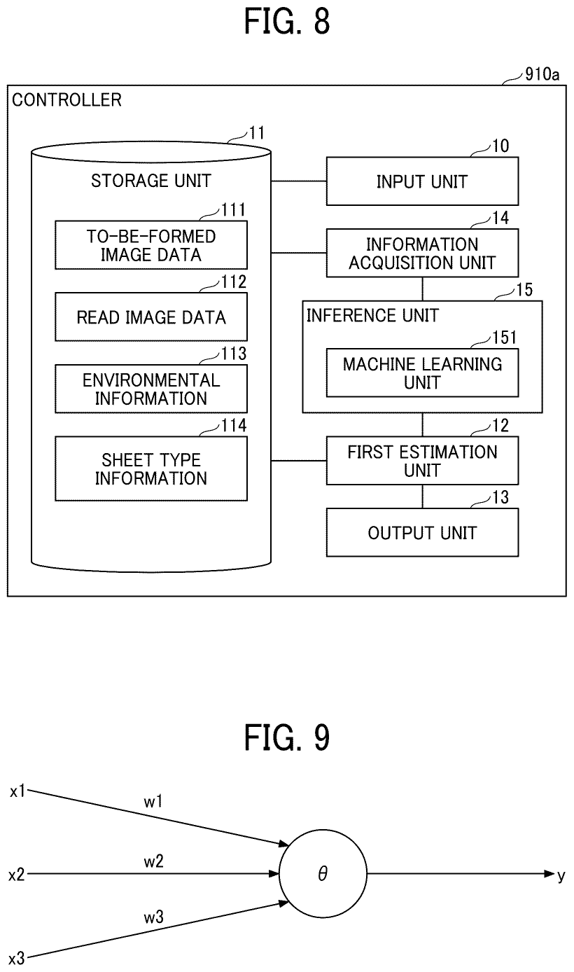

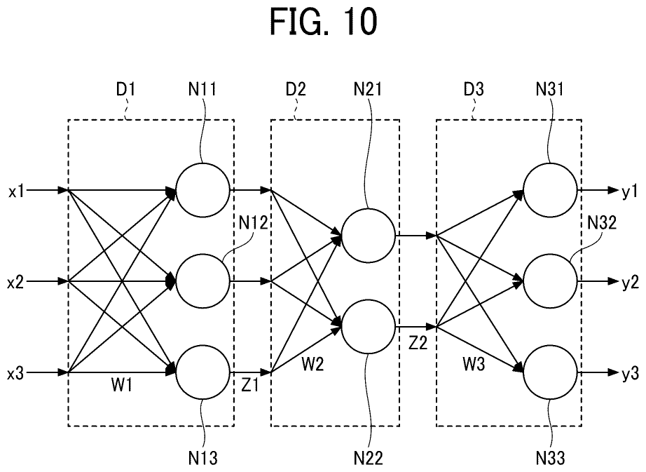

The machine learning unit 151 preferably generates, through machine learning, the learning model LM of a neural network that receives, as input, the environmental information 113 and the sheet type information 114 of the sheet P and outputs the correction parameter. FIG. 9 is a schematic diagram of the learning model LM of a neuron. FIG. 10 is a schematic diagram of the learning model LM of a three-layer neural network including a combination of the neurons illustrated in FIG. 9. A neural network is implemented by, for example, an arithmetic device and a memory that imitate the model of the neurons (simple perceptrons) illustrated in FIG. 9.

As illustrated in FIG. 9, the neuron outputs an output (result) y for a plurality of inputs x. In the example illustrated in FIG. 9, inputs x1 to x3 correspond to the plurality of inputs x. The inputs x (x1, x2, x3) are respectively multiplied by weights w (w1, w2, w3) corresponding to these inputs x. Thus, the neuron outputs the output y which is represented by Equation 1. The inputs x, the output y, and the weights w are all vectors. In Equation 1 below, θ denotes a bias and fk denotes an activation function.

$$y = {f}_{k} ( {\sum }_{i = 1}^{n} {x}_{i} {w}_{i} - θ ) \qquad Equation 1$$

FIG. 10 illustrates the three-layer neural network including a combination of the neurons illustrated in FIG. 9. As illustrated in FIG. 10, a plurality of inputs x are input to the neural network having three layers (D1, D2, D3) from the left side, and outputs y are output from the right side. In the example illustrated in FIG. 10, inputs x1 to x3 correspond to the plurality of inputs x. Outputs y1 to y3 correspond to the outputs y. Specifically, the inputs x1, x2, and x3 are multiplied by corresponding weights and input to each of three neurons N11 to N13. The weights which the inputs x1, x2, and x3 are multiplied by are collectively denoted by W1.

The neurons N11 to N13 output z11 to z13, respectively. In FIG. 10, the outputs z11 to z13 are collectively denoted by a feature vector Z1, which can be regarded as a vector obtained by extracting feature quantities of the input vectors. This feature vector Z1 is a feature vector between the weights W1 and W2. The outputs z11 to z13 are multiplied by corresponding weights and input to each of two neurons N21 and N22. The weights which the feature vector Z1 is multiplied by are collectively denoted by W2.

The neurons N21 and N22 output z21 and z22, respectively. In FIG. 10, the outputs z21 and z22 are collectively denoted by a feature vector Z2. This feature vector Z2 is a feature vector between the weights W2 and W3. The outputs z21 and z22 are multiplied by corresponding weights and input to each of three neurons N31 to N33. The weights which the feature vector Z2 is multiplied by are collectively denoted by W3.

Lastly, the neurons N31 to N33 output the outputs y1 to y3, respectively.

The operation of the neural network includes a learning mode in which the weights W1 to W3 of the neural network are learned, and an estimation mode in which the outputs y1 to y3 are estimated from the inputs x1 to x3. For example, in the learning mode, the weights W1 to W3 are learned using a training dataset. In the estimation mode, the resulting parameters are used to infer a correction parameter α. For the sake of convenience, the term “estimation” is used. However, the neural network can handle various tasks such as detection and classification.

The weights W1 to W3 can be learned through backpropagation. Information on errors is input from the right side of the neural network and flows to the left side. The backpropagation is a method of adjusting (learning), for each neuron, each weight to reduce a difference (i.e., error) between the output y obtained when the input x is input and the ground truth output y (i.e., labeled data).

Such a neural network may have an increased number of layers such as more than three layers to perform deep learning. An arithmetic device having a convolutional neural network (CNN) that extracts features of the inputs stepwise and a neural network that classifies or regresses the outputs can be automatically acquired from labeled training data.

### Operation of Image Forming Apparatus According to Second Embodiment

### Operation of Generating Learning Model LM

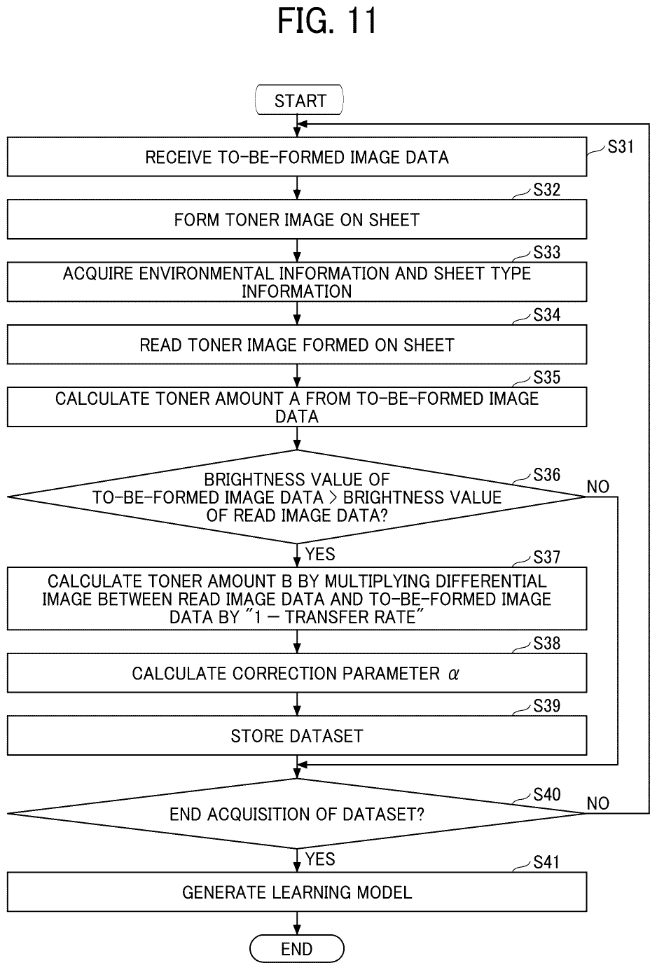

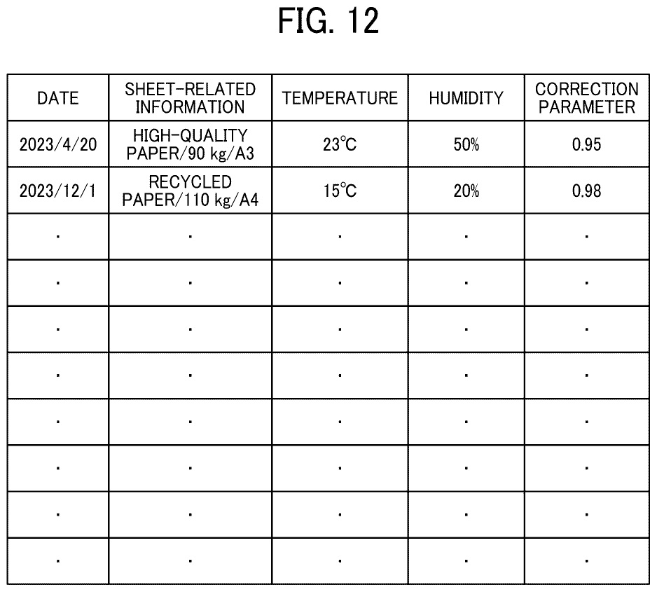

An operation of generating the learning model LM performed by the image forming apparatus 1 according to the second embodiment will be described with reference to FIGS. 11 and 12. FIG. 11 is a flowchart illustrating the operation of generating the learning model LM performed by the image forming apparatus 1. FIG. 12 is a diagram illustrating an example of a training dataset used in generation of the learning model LM by the image forming apparatus 1.

The image forming apparatus 1 starts the operation in FIG. 11 in response to reception of an input operation to start generation of the learning model LM via the control panel 940 from an operator of the image forming apparatus 1, for example.

In step S31, the image forming apparatus 1 receives the to-be-formed image data 111 sent by the operator of the image forming apparatus 1.

In step S32, the image forming apparatus 1 forms a toner image on the sheet P based on the received to-be-formed image data 111.

In step S33, the image forming apparatus 1 acquires, with the information acquisition unit 14, the environmental information 113 input from the temperature/humidity detector 255 and the sheet type information 114 of the sheet P.

In step S34, the image forming apparatus 1 reads, with the image reader 270, the toner image formed on the sheet P. Consequently, the image forming apparatus 1 obtains the read image data 112 of the toner image.

In step S35, the image forming apparatus 1 calculates the toner amount Abased on the to-be-formed image data 111. The toner amount A is obtained by multiplying a toner amount used for the image of the to-be-formed image data 111 by “1−transfer rate”.

In step S36, the image forming apparatus 1 determines whether a brightness value of the to-be-formed image data 111 is greater than a brightness value of the read image data 112.

If it is determined in step S36 that the brightness value of the to-be-formed image data 111 is not greater than the brightness value of the read image data 112 (NO in step S36), the image forming apparatus 1 causes the operation to proceed to step S40. On the other hand, if it is determined in step S36 that the brightness value of the to-be-formed image data 111 is greater than the brightness value of the read image data 112 (YES in step S36), the image forming apparatus 1 performs step S37. In step S37, the image forming apparatus 1 calculates the toner amount B from a differential image between the read image data 112 and the to-be-formed image data 111.

In step 538, the image forming apparatus 1 divides the toner amount B by the toner amount A to calculate the correction parameter α. In this case, the correction parameter α is the value (α=B/A) obtained by dividing the toner amount B calculated in step S37 by the toner amount A calculated in step S35 and is a coefficient for calculating an excess/deficiency of the residual toner caused relative to the to-be-formed image data 111.

In step S39, the image forming apparatus 1 stores a training dataset including the sheet type information 114 of the sheet P, the temperature information and the humidity information of the environmental information 113, and the correction parameter α in, for example, the storage unit 11. As illustrated in FIG. 12, training datasets each including the sheet type information 114 of the sheet P (sheet-related information), the temperature information and the humidity information of the environmental information 113, and the correction parameter α associated with one another are accumulated and stored. In the example illustrated in FIG. 12, the training dataset includes date information about the formation date of the toner image on the sheet P in step S32.

In step S40, the image forming apparatus 1 determines whether to end the acquisition of the training dataset. For example, the image forming apparatus 1 determines to end the acquisition when a predetermined number of training datasets are acquired. Alternatively, the image forming apparatus 1 ends the acquisition when the learning model LM achieves a predetermined target index or the group of the acquired datasets is in a certain data distribution (that is, the data is bias-free).

If it is determined in step S40 not to end the acquisition (NO in step S40), the image forming apparatus 1 performs the operation in and after step S31 again and repeats the operation until it is determined to end the acquisition in step S40. On the other hand, if it is determined in step S40 to end the acquisition (YES in step S40), the image forming apparatus 1 performs step S41. In step S41, the image forming apparatus 1 performs, with the machine learning unit 151, machine learning using the training datasets stored in, for example, the storage unit to generate the learning model LM. The learning model LM generated in FIG. 11 receives, as input, the environmental information 113 and the sheet type information 114 of the sheet P, and outputs the correction parameter α for correcting the estimated amount of the residual toner amount estimated from the to-be-formed image data 111. After generating the learning model LM, the image forming apparatus 1 ends the operation.

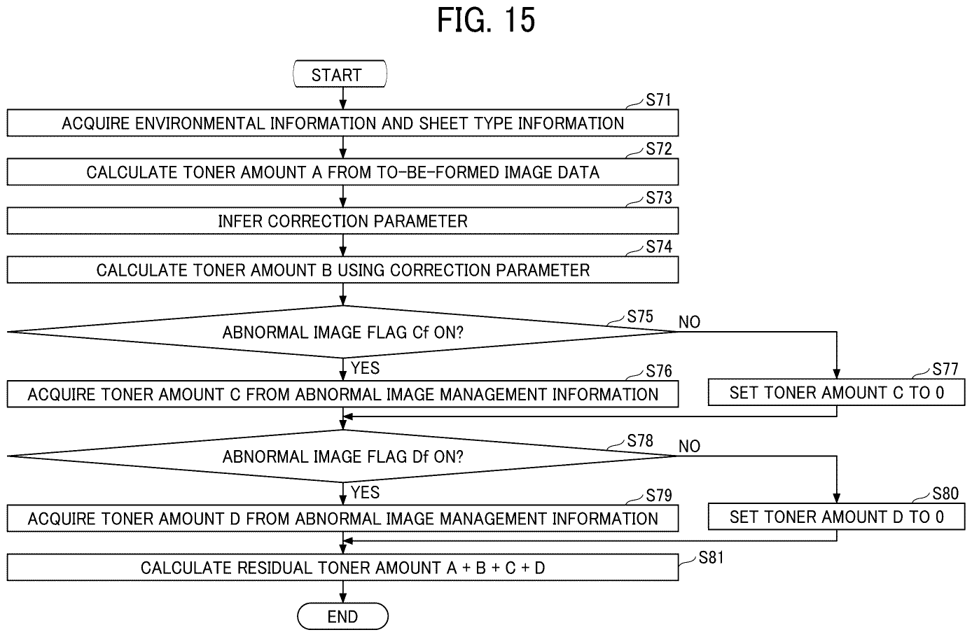

In the above-described manner, the image forming apparatus 1 can generate the learning model LM. The image forming apparatus 1 can acquire a training dataset including the environmental information 113 and the sheet type information 114 of the sheet P and the toner amount A and the toner amount B corresponding to these pieces of information while performing the residual toner amount estimation process illustrated in FIG. 7. The image forming apparatus 1 can generate the learning model LM and update the learning model LM using the training dataset acquired while performing the residual toner amount estimation process. The image forming apparatus 1 can acquire a training dataset while performing a residual toner amount estimation process illustrated in FIG. 15 (described later) and update the learning model LM using the acquired training dataset.

### Operation of Creating Abnormal Image Management Information

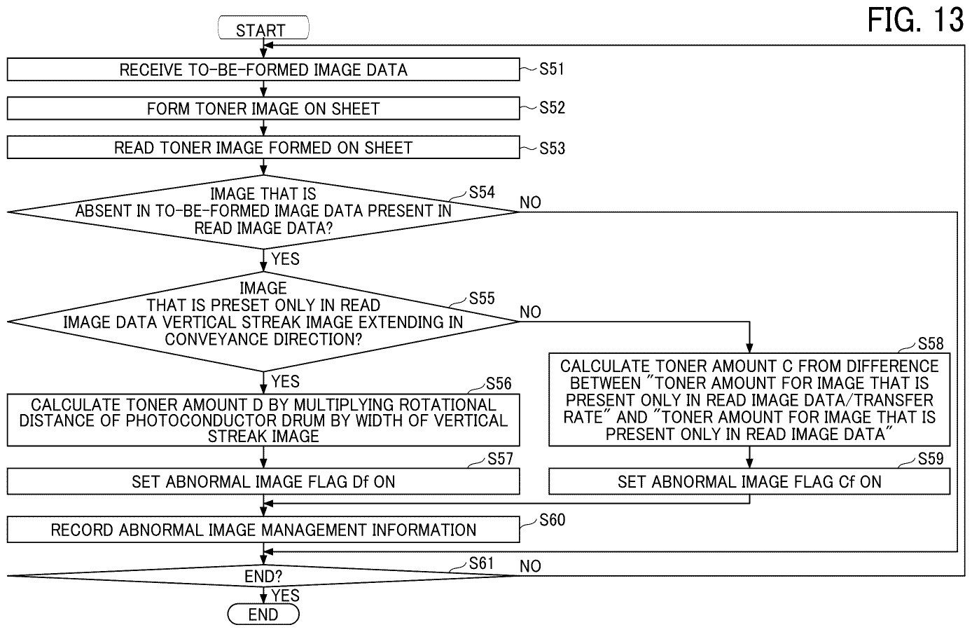

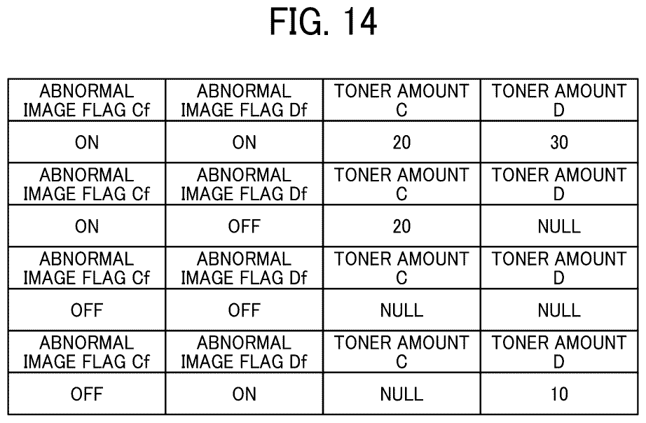

An operation of creating abnormal image management information performed by the image forming apparatus 1 according to the second embodiment will be described with reference to FIGS. 13 and 14. FIG. 13 is a flowchart illustrating the operation of creating the abnormal image management information performed by the image forming apparatus 1. FIG. 14 is a diagram illustrating an example of the abnormal image management information in the image forming apparatus 1.

The abnormal image management information refers to information indicating a correspondence between an abnormal image and a residual toner amount. When the inference unit 15 infers the correction parameter α, the image forming apparatus 1 does not read an image formed on the sheet P and thus does not calculate the toner amount C and the toner amount D based on the read image data 112. Therefore, in this case, the image forming apparatus 1 acquires the toner amount C and the toner amount D in accordance with the identified type of the abnormal image with reference to the abnormal image management information. The abnormal image management information is managed separately from the learning model LM. The abnormal image management information includes an abnormal image flag to be set on in the event of an abnormal image in addition to the correspondence between the abnormal image and the residual toner amount.

The image forming apparatus 1 starts the operation in FIG. 13 in response to reception of an input operation to start creation of the abnormal image management information via the control panel 940 from the operator of the image forming apparatus 1, for example.

In step S51, the image forming apparatus 1 receives the to-be-formed image data 111 sent by the operator of the image forming apparatus 1.

In step S52, the image forming apparatus 1 forms a toner image on the sheet P based on the received to-be-formed image data 111.

In step S53, the image forming apparatus 1 reads, with the image reader 270, the toner image formed on the sheet P. Consequently, the image forming apparatus 1 obtains the read image data 112 of the toner image.

In step S54, the image forming apparatus 1 determines whether an image that is absent in the to-be-formed image data 111 is present in the read image data 112. If it is determined in step S54 that an image that is absent in the to-be-formed image data 111 is absent in the read image data 112 (NO in step S54), the image forming apparatus 1 causes the operation to proceed to step S61.

On the other hand, if it is determined in step S54 that an image that is absent in the to-be-formed image data 111 is present in the read image data 112 (YES in step S54), the image forming apparatus 1 performs step S55. In step S55, the image forming apparatus 1 determines whether the image that is present only in the read image data 112 is the vertical streak image E extending in the conveyance direction Pa.

If it is determined in step S55 that the image that is present only in the read image data 112 is the vertical streak image E (YES in step S55), the image forming apparatus 1 performs step S56. In step S56, the image forming apparatus 1 calculates the toner amount D by multiplying a rotational distance of the photoconductor drum 231 by the width of the vertical streak image E.

In step S57, the image forming apparatus 1 sets an abnormal image flag Df on.

On the other hand, if it is determined in step S55 that the image that is present only in the read image data 112 is not the vertical streak image E (NO in step S55), the image forming apparatus 1 performs step S58. In step S58, the image forming apparatus 1 calculates the toner amount C by subtracting the “toner amount for the image that is present only in the read image data” from the “toner amount for the image that is present only in the read image data/transfer rate”.

In step S59, the image forming apparatus 1 sets an abnormal image flag Cf on. The abnormal image in step S59 is an abnormal image of so-called scumming in which toner adheres to an image-data-free area on the outer surface of the photoconductor drum 231 due to deterioration of the photoconductor drum 231, which has been described in the second example of the read image data 112 above.

In step 560, the image forming apparatus 1 records the abnormal image flag Cf, the abnormal image flag Df, the toner amount C, and the toner amount D in the abnormal image management information. As illustrated in FIG. 14, the abnormal image flag Cf and the abnormal image flag Df are respectively associated with information on the toner amount C and information on the toner amount D, and are recorded in the abnormal image management information. In the case where the latest abnormal image flag is on, the toner amount calculated when the abnormal image flag is set on is recorded. Since information on the toner amount is absent in the case where the abnormal image flag is off, NULL is set.

In step S61, the image forming apparatus 1 determines whether to end the creation of the abnormal image management information. For example, the image forming apparatus 1 determines to end the creation of the abnormal image management information in response to receipt of an input operation to end the creation of the abnormal image management information via the control panel 940 from the operator of the image forming apparatus 1.

If it is determined in step S61 not to end the creation (NO in step S61), the image forming apparatus 1 performs the operation in and after step S51 again and repeats the operation until it is determined to end the creation in step S61. On the other hand, if it is determined in step S61 to end the creation (YES in step S61), the image forming apparatus 1 ends the operation.

In the above-described manner, the image forming apparatus 1 can create the abnormal image management information. The abnormal image management information is stored in the storage unit 11, for example. The image forming apparatus 1 can record the calculated toner amount C and toner amount D while performing the residual toner amount estimation process illustrated in FIG. 7 to create the abnormal image management information.

### Operation of Estimating Residual Toner Amount

An operation of estimating a residual toner amount performed by the image forming apparatus 1 according to the second embodiment will be described with reference to FIG. 15. FIG. 15 is a flowchart illustrating the operation of estimating the residual toner amount performed by the image forming apparatus 1. For example, the image forming apparatus 1 starts the operation of FIG. 15 in response to reception of the to-be-formed image data 111 from the image forming apparatus 1.

In step 571, the image forming apparatus 1 acquires the environmental information 113 input from the temperature/humidity detector 255 and the sheet type information 114 of the sheet P.

In step S72, the image forming apparatus 1 calculates, with the first estimation unit 12, the toner amount A based on the to-be-formed image data 111. The toner amount A is obtained by multiplying a toner amount used for the image of the to-be-formed image data 111 by “1−transfer rate”.

In step 573, the image forming apparatus 1 infers, with the inference unit 15, the correction parameter α using the learning model LM based on the environmental information 113 and the sheet type information 114 of the sheet P.

In step 574, the image forming apparatus 1 calculates, with the first estimation unit 12, the toner amount B using the correction parameter α. Specifically, the first estimation unit 12 calculates the toner amount B by multiplying the toner amount A obtained in step S72 by the correction parameter α. This enables the toner amount B to be calculated based on a difference between the toner amount of the image of the to-be-formed image data 111 formed on the sheet and the toner amount supposed to be used for the to-be-formed image data 111 without reading the image formed on the sheet P.

In step S75, the image forming apparatus 1 determines whether the abnormal image flag Cf is on with reference to the abnormal image management information. If it is determined in step S75 that the abnormal image flag Cf is on (YES in step S75), the image forming apparatus 1 acquires, with the first estimation unit 12, the toner amount C with reference to the abnormal image management information in step S76. If it is determined in step S75 that the abnormal image flag Cf is not on (NO in step S75), the image forming apparatus 1 sets, with the first estimation unit 12, the toner amount C to 0 in step S77.

In step S78, the image forming apparatus 1 determines whether the abnormal image flag Df is on with reference to the abnormal image management information. If it is determined in step S78 that the abnormal image flag Df is on (YES in step S78), the image forming apparatus 1 acquires, with the first estimation unit 12, the toner amount D with reference to the abnormal image management information in step S79. If it is determined in step S78 that the abnormal image flag Df is not on (NO in step S78), the image forming apparatus 1 sets, with the first estimation unit 12, the toner amount D to 0 in step S80.

In step S81, the image forming apparatus 1 calculates, with the first estimation unit 12, the residual toner amount from the sum of the toner amount A, the toner amount B, the toner amount C, and the toner amount D, and sets the result as an estimation result of the residual toner amount. The image forming apparatus 1 then ends the operation.

In the above-described manner, the image forming apparatus 1 can estimate the residual toner amount.

In the present embodiment, the inference unit 15 uses the learning model LM to infer the correction parameter α from the environmental information 113 and the sheet type information 114 of the sheet P acquired by the information acquisition unit 14. The first estimation unit 12 uses the correction parameter α to correct the residual toner amount. This can reduce the error in estimating the residual toner amount based on the environmental information 113 and the sheet type information 114 of the sheet P and increase the estimation accuracy of the amount of residual toner in the present embodiment. The use of the learning model LM omits reading of the sheet P at every estimation of the residual toner amount in the present embodiment. This makes it easier to estimate the residual toner amount.

The inference unit 15 includes the machine learning unit 151 that generates the learning model LM. This allows the image forming apparatus 1 to generate, with the machine learning unit 151, the learning model LM, and estimate the residual toner amount using the generated learning model LM. The machine learning unit 151 can update the learning model LM in accordance with the installed location or usage state of the image forming apparatus 1. This can optimize the learning model LM and further increase the estimation accuracy of the amount of residual toner.

### Third Embodiment

An image forming apparatus according to a third embodiment of the present disclosure will be described next.

### Configuration of Image Forming Apparatus According to Third Embodiment

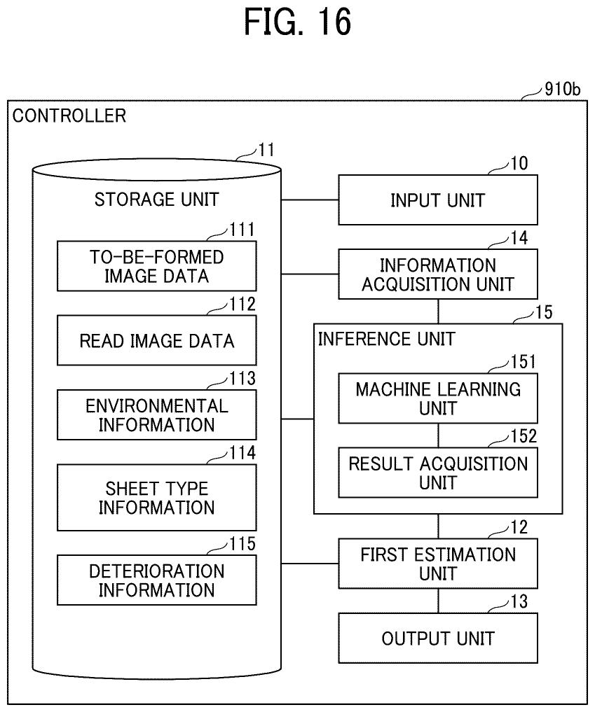

FIG. 16 is a block diagram illustrating a functional configuration of a controller 910b included in the image forming apparatus 1 according to the present embodiment.

As illustrated in FIG. 16, in the present embodiment, the inference unit 15 includes a result acquisition unit 152 that acquires validity information as to whether correction for the residual toner amount is correct. The machine learning unit 151 updates the learning model LM based on the validity information acquired by the result acquisition unit 152. That is, in the present embodiment, the inference unit 15 can update the learning model LM through additional learning based on the validity information. The machine learning unit 151 further uses deterioration information 115 of the image bearer as input for learning. These points are different from the image forming apparatus 1 according to the second embodiment.

The validity information is input to the controller 910b via the control panel 940 from a service person or user of the image forming apparatus 1 when the service person or user replaces the accommodating member 260 that has become full with the collected residual toner, for example. Specifically, the service person or user measures the weight of the residual toner accommodated in the accommodating member 260 and inputs information on the weight as the validity information to the controller 910b via the control panel 940. This allows the result acquisition unit 152 to acquire the validity information from the service person or user via the control panel 940.

The deterioration information 115 of the image bearer used by the machine learning unit 151 as input includes information such as an elapsed time since the use of the image bearer is started, a rotational distance of the image bearer, and the number of sheets P on which images have been formed by the image forming apparatus 1. In the example illustrated in FIG. 1, the image bearer corresponds to the photoconductor drums 231 and the intermediate transfer belt 243.

### Operation of Image Forming Apparatus According to Third Embodiment

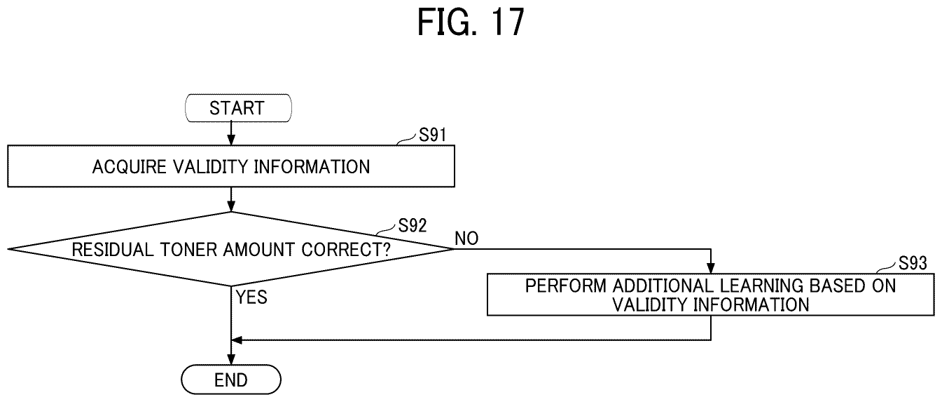

FIG. 17 is a flowchart illustrating an additional learning operation performed by the image forming apparatus 1 according to the third embodiment. The image forming apparatus 1 starts the operation of FIG. 17 in response to displaying of a message prompting replacement of the accommodating member 260 on the control panel 940 or transmitting the message by email, for example.

In step S91, the image forming apparatus 1 acquires, with the result acquisition unit 152, the validity information as to whether correction for the residual toner amount is correct. For example, the result acquisition unit 152 acquires, as the validity information, weight information on the weight of the residual toner measured by the service person or user of the image forming apparatus 1 who has recognized the message prompting the replacement of the accommodating member 260.

In step S92, the image forming apparatus 1 determines whether the residual toner amount is correct in accordance with the validity information acquired by the result acquisition unit 152. If it is determined in step S92 that the residual toner amount is correct (YES in step S92), the image forming apparatus 1 determines not to perform additional learning and ends the operation.

On the other hand, if it is determined in step S92 that the residual toner amount is not correct (NO in step S92), the image forming apparatus 1 performs, with the machine learning unit 151, additional learning based on the validity information and the deterioration information 115 of the image bearer in step S93. In additional learning, a weight freezing method, a weight constraint method, or a weight expansion method may be used. However, the weight expansion method is preferably used in terms of expanding the weights of the existing learning model LM while imposing constraints on the weights of the existing model to add components for handling new data or tasks. The machine learning unit 151 performs additional learning based on the validity information acquired by the result acquisition unit 152 to update the learning model LM.

In the above-described manner, the image forming apparatus 1 can perform additional learning to appropriately update the learning model LM in accordance with the use environment of the image forming apparatus 1. In the present embodiment, when the learning model LM becomes unsuitable because of the use environment of the image forming apparatus 1, the learning model LM is updated through additional learning in accordance with the use environment. This can optimize the inferred correction parameter α. For example, when the learning model LM becomes unsuitable because of the addition of a new kind of the sheet P, the correction parameter α can be favorably optimized. The optimized correction parameter α increases the estimation accuracy of the amount of residual toner.

Even when the type of the sheet P, the temperature, and the humidity are the same, the amount of residual toner may change because of deterioration of the image bearer such as the photoconductor drum 231. In the present embodiment, the learning model LM is used that receives, as input, the deterioration information 115 of the image bearer as well as the environmental information 113 and the sheet type information 114 of the sheet P and outputs the correction parameter α. The inference unit 15 uses the learning model LM to infer the correction parameter α from the environmental information 113, the sheet type information 114 of the sheet P, and the deterioration information 115 of the image bearer acquired by the information acquisition unit 14.

The deterioration information 115 of the image bearer is, for example, information that allows estimation of aging deterioration of the image bearer such as a total rotational distance or a total driven time of the image bearer (i.e., the photoconductor drum 231 or the intermediate transfer belt 243). The first estimation unit 12 uses the correction parameter α inferred by the inference unit 15 to correct the residual toner amount. This can reduce the influence of the deterioration of the image bearer and further increase the estimation accuracy of the amount of residual toner in the present embodiment.

### Fourth Embodiment

An image forming apparatus according to a fourth embodiment will be described next.

### Configuration of Image Forming Apparatus According to Fourth Embodiment

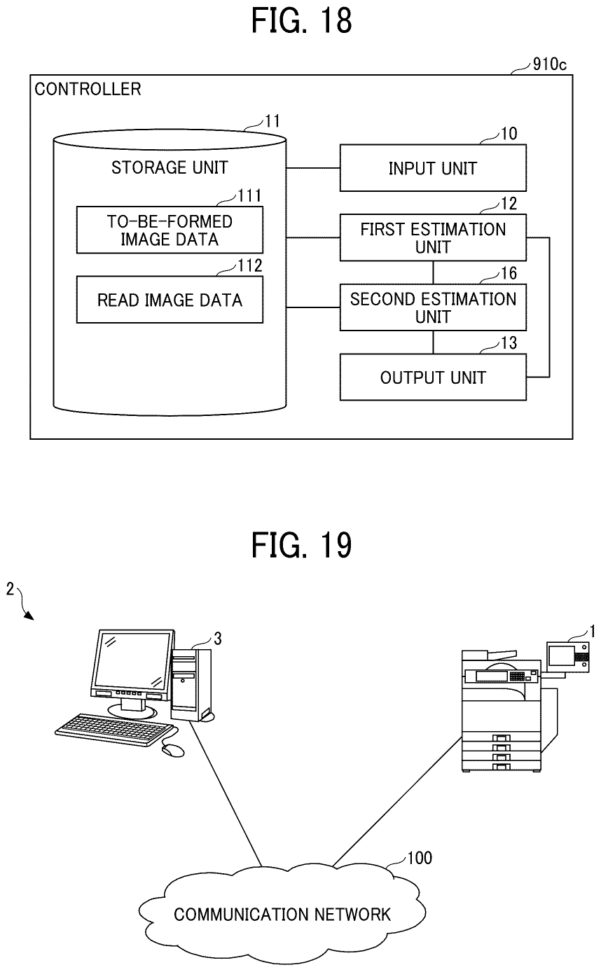

FIG. 18 is a block diagram illustrating a functional configuration of a controller 910c included in the image forming apparatus 1 according to the present embodiment.

As illustrated in FIG. 18, the image forming apparatus 1 according to the present embodiment differs from the image forming apparatus 1 according to the first embodiment in that the controller 910c further includes a second estimation unit 16. The second estimation unit 16 estimates a toner consumption amount based on the residual toner amount estimated by the first estimation unit 12 and the read image data 112 of the toner image formed on the sheet P and read with the image reader 270.

Functions of the second estimation unit 16 are implemented by an electronic circuit such as the CPU 901 executing instruction code stored in a memory such as the ROM 902a or an electronic circuit whose circuitry is designed for a specific purpose executing various processes, for example. Part of the functions of the second estimation unit 16 may be implemented by one or more devices or apparatuses other than the controller 910c or through distributed processing by the controller 910c and one or more devices or apparatuses other than the controller 910c.

The toner consumption amount in an image forming apparatus includes an amount of toner collected as residual toner as well as an amount of toner used in formation of an image on the sheet P. In the present embodiment, the second estimation unit 16 estimates the amount of toner used in formation of an image on the sheet P based on the read image data 112. The second estimation unit 16 receives information on the residual toner amount estimated by the first estimation unit 12 from the first estimation unit 12. The second estimation unit 16 estimates the toner consumption amount by adding the toner amount used in formation of an image on the sheet P and the residual toner amount together.

The first estimation unit 12 can estimate the residual toner amount with high accuracy. This allows the second estimation unit 16 to estimate the toner consumption amount with high accuracy by using the residual toner amount estimated by the first estimation unit 12. The second estimation unit 16 can output the estimation result of the toner consumption amount via the output unit 13.

Highly accurate estimation of the toner consumption amount enables appropriate management of the replacement timings of the toner cartridges 234Y, 234C, 234M, and 234K. For example, the image forming apparatus 1 can prompt the service person or administrator thereof to replace the toner cartridges 234Y, 234C, 234M, and 234K at appropriate timings. The image forming apparatus 1 can also reduce the unnecessary cost of replacing the toner cartridges 234Y, 234C, 234M, and 234K in which toner still remains. The image forming apparatus 1 can further reduce the downtime of the image forming apparatus 1 due to the absence of toner in the toner cartridges 234Y, 234C, 234M, and 234K.

The controller 910c according to the present embodiment may include the inference unit 15 and infer, with the inference unit 15, the correction parameter α, which can be used to estimate the residual toner amount. The first estimation unit 12 may estimate the residual toner amount using the correction parameter α inferred by the inference unit 15.

### Fifth Embodiment

An image forming system according to a fifth embodiment of the present disclosure will be described next.

### Configuration of Image Forming System According to Fifth Embodiment General Arrangement

FIG. 19 is a schematic diagram illustrating a general arrangement of an image forming system 2 according to the fifth embodiment. As illustrated in FIG. 19, the image forming system 2 includes the image forming apparatus 1 and a server 3 that is communicatively connected to the image forming apparatus 1 via the communication network 100 such as the Internet or a LAN.

### Hardware Configuration of Server 3

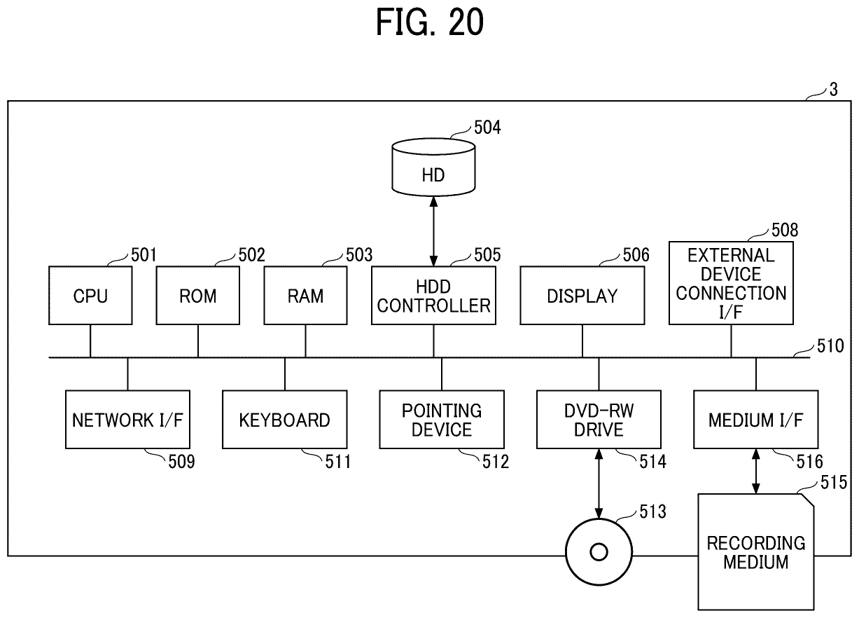

FIG. 20 is a block diagram illustrating an example of a hardware configuration of the server 3.

The server 3 is implemented by a computer. The server 3 includes a CPU 501, a ROM 502, a RAM 503, an HD 504, an HDD controller 505, a display 506, an external device connection I/F 508, a network I/F 509, a bus line 510, and a keyboard 511. The server 3 also includes a pointing device 512, a digital versatile disk rewritable (DVD-RW) drive 514, and a medium I/F 516.

The CPU 501 controls the overall operation of the server 3. The ROM 502 stores programs, such as an initial program loader (IPL), for driving the CPU 501. The RAM 503 is used as a work area for the CPU 501. The HD 504 stores various types of data such as a program. The HDD controller 505 controls reading and writing of various types of data from and to the HD 504 under the control of the CPU 501.

The display 506 displays various types of information such as a cursor, a menu, a window, a text, or an image. The external device connection I/F 508 is an interface for connecting various external devices to the server 3. Examples of the external devices include, but are not limited to, a USB memory and a printer. The network I/F 509 is an interface that enables communication of data via the communication network 100. The bus line 510 is, for example, an address bus or a data bus that electrically connects the components such as the CPU 501 with one another.

The keyboard 511 is an example of an input device including a plurality of buttons with which characters, numerical values, and various instructions are input. The pointing device 512 is an example of an input device with which, for example, selecting or executing various kinds of instructions, selecting a target for processing, or moving a cursor are performed. The DVD-RW drive 514 controls reading or writing of various types of data from or to a DVD-RW 513, which is an example of a removable recording medium. The removable recording medium is not limited to the DVD-RW and may be a digital versatile disk-recordable (DVD-R).

The medium I/F 516 controls reading or writing (storing) of data from or to a recording medium 515 such as a flash memory.

Functional Configuration of Controller 910d FIG. 21 is a block diagram illustrating a functional configuration of a controller 910d of the image forming apparatus 1 included in the image forming system 2.

The information acquisition unit 14 acquires the environmental information 113 and the sheet type information 114 of the sheet P from the storage unit 11, and transmits the environmental information 113 and the sheet type information 114 of the sheet P to the server 3 via the output unit 13. The server 3 infers the correction parameter α based on the environmental information 113 and the sheet type information 114 of the sheet P transmitted thereto. The server 3 transmits the correction parameter α, which is the inference result, to the controller 910d.

The first estimation unit 12 receives the correction parameter α from the server 3 via the input unit 10. The first estimation unit 12 calculates the toner amount B using the correction parameter α. The first estimation unit 12 also calculates the toner amount A from the to-be-formed image data 111. The first estimation unit 12 further acquires the toner amount C and the toner amount D with reference to the abnormal image management information or sets the toner amount C and the toner amount D to 0 in accordance with the abnormal image flags. The first estimation unit 12 adds the toner amount A, the toner amount B, the toner amount C, and the toner amount D together to calculate the residual toner amount. The first estimation unit 12 can output the estimation result of the residual toner amount via the output unit 13.

### Functional Configuration of Server 3

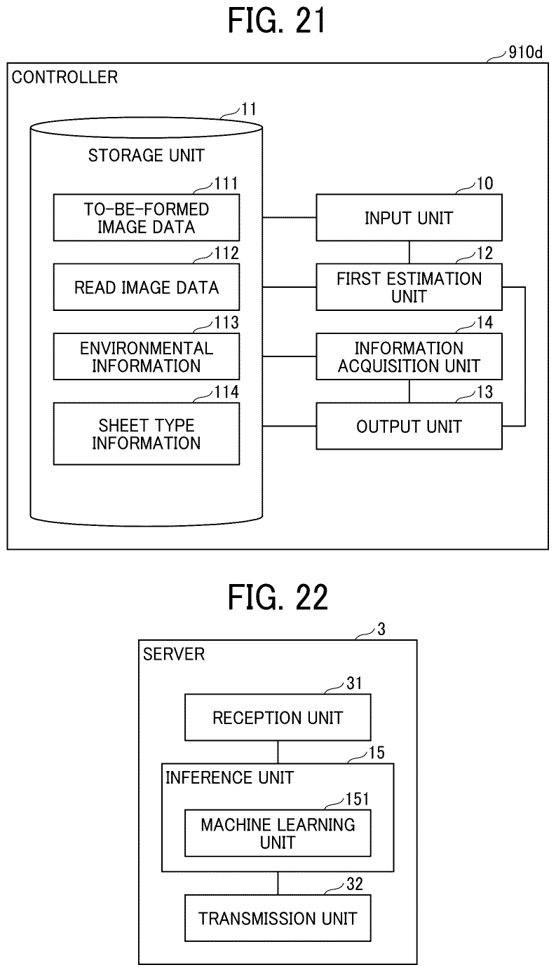

FIG. 22 is a block diagram illustrating a functional configuration of the server 3 included in the image forming system 2.

The server 3 includes a reception unit 31, the inference unit 15, and a transmission unit 32. The inference unit 15 included in the server 3 receives, as input via the reception unit 31, the environmental information 113 and the sheet type information 114 of the sheet P transmitted from the controller 910d. The inference unit 15 infers the correction parameter α using the learning model LM, and transmits the inferred correction parameter α to the controller 910d via the transmission unit 32.

In the present embodiment, the inference unit 15 included in the server 3 infers the correction parameter α. This allows the image forming apparatus 1 to acquire the correction parameter α while reducing the computation load of the controller 910d of the image forming apparatus 1. In the present embodiment, the residual toner amount can be estimated with high accuracy using the correction parameter α. Effects other than the above one are the same as those of the image forming apparatus 1 according to the second embodiment.

The controller 910d may include the second estimation unit 16. The second estimation unit 16 may estimate the toner consumption amount of the image forming apparatus 1 using information on the residual toner amount estimated by the first estimation unit 12.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The numbers such as ordinal number and quantity used in the description of the above embodiments are all illustrative for the purpose of specifically describing the technology of the embodiments, and the embodiments are not limited to the illustrative numbers. In addition, a connection relation between the components is illustrative for specifically describing the technology of the embodiments, and a connection relation for implementing the functions of the embodiments is not limited thereto.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

Aspects of the present disclosure are, for example, as follows.

According to Aspect 1, an image forming apparatus to form a toner image on a sheet includes an image bearer, a cleaning device, an image reader, and a controller. The image bearer bears the toner image. The cleaning device collects residual toner that remains untransferred on the image bearer. The image reader reads the toner image formed on the sheet. The controller controls an operation of the image forming apparatus. The controller includes a first estimation unit. The first estimation unit identifies a type of an abnormal image, based on a difference between to-be-formed image data of the toner image to be formed on the sheet and read image data of the toner image formed on the sheet and read by the image reader, and estimates a residual toner amount of the residual toner resulting from the abnormal image of the identified type.

According to Aspect 2, in the image forming apparatus of Aspect 1, the controller includes an information acquisition unit and an inference unit. The information acquisition unit acquires environmental information inside the image forming apparatus and sheet type information of the sheet on which the toner image is to be formed. The inference unit infers a correction parameter using a learning model from the environmental information and the sheet type information acquired by the information acquisition unit. The learning model is a model that receives, as input, the environmental information and the sheet type information acquired by the information acquisition unit and outputs the correction parameter for correcting an estimated amount of the residual toner. The estimated amount is the residual toner amount estimated from the to-be-formed image data. The first estimation unit corrects the residual toner amount estimated from the to-be-formed image data, using the correction parameter inferred by the inference unit.

According to Aspect 3, in the image forming apparatus of Aspect 2, the inference unit includes a machine learning unit. The machine learning unit generates the learning model that receives, as the input, the environmental information and the sheet type information and outputs the correction parameter.

According to Aspect 4, in the image forming apparatus of Aspect 3, the inference unit includes a result acquisition unit. The result acquisition unit acquires validity information as to whether correction for the residual toner amount is correct. The machine learning unit updates the learning model based on the validity information acquired by the result acquisition unit.

According to Aspect 5, in the image forming apparatus of Aspect 3, the machine learning unit further uses deterioration information of the image bearer as the input to train the learning model.

According to Aspect 6, in the image forming apparatus of any one of Aspect 1 to 5, the controller further includes a second estimation unit. The second estimation unit estimates a toner consumption amount based on the residual toner amount estimated by the first estimation unit and the read image data of the toner image formed on the sheet and read by the image reader.

According to Aspect 7, in the image forming apparatus of any one of Aspect 1 to 6, the first estimation unit uses a calculation method corresponding to the identified type of the abnormal image to estimate the residual toner amount of the residual toner resulting from the abnormal image of the identified type.

According to Aspect 8, in the image forming apparatus of any one of Aspects 1 to 7, when the abnormal image of the identified type is a vertical streak image extending in a conveyance direction of the sheet, the first estimation unit multiplies a rotational distance of the image bearer by a width of the vertical streak image to estimate a residual toner amount of the residual toner resulting from the vertical streak image.

According to Aspect 9, in the image forming apparatus of any one of Aspects 1 to 8, when the abnormal image of the identified type is not a vertical streak image extending in a conveyance direction of the sheet, the first estimation unit subtracts a toner amount for an image that is present only in the read image data from a value obtained by dividing the toner amount for the image that is present only in the read image data by a transfer rate to estimate the residual toner amount of the residual toner resulting from the abnormal image.

According to Aspect 10, in the image forming apparatus of any one of Aspect 1 to 9, the controller records abnormal image management information. The abnormal image management information is information in which, for each type of the abnormal image, presence or absence of the abnormal image and the residual toner amount, estimated by the first estimation unit, of the residual toner resulting from the abnormal image are associated with each other.

According to Aspect 11, an image forming method performed by an image forming apparatus to form a toner image on a sheet, includes: the image forming apparatus bearing, with an image bearer, a toner image; the image forming apparatus collecting, with a cleaning device, residual toner that remains untransferred on the image bearer; the image forming apparatus reading, with an image reader, the toner image formed on the sheet; and the image forming apparatus controlling, with a controller, an operation of the image forming apparatus. The controller identifies, with a first estimation unit, a type of an abnormal image, based on a difference between to-be-formed image data of the toner image to be formed on the sheet and read image data of the toner image formed on the sheet and read by the image reader; and estimates, with the first estimation unit, a residual toner amount of the residual toner resulting from the abnormal image of the identified type.

According to Aspect 12, a program runs on an image forming apparatus to form a toner image on a sheet and causes the image forming apparatus to execute a process. The process includes causing an image bearer to bear a toner image; causing a cleaning device to collect residual toner that remains untransferred on the image bearer; causing an image reader to read the toner image formed on a sheet; and causing a controller to control an operation of the image forming apparatus.

The controller causes a first estimation unit to identify a type of an abnormal image, based on a difference between to-be-formed image data of the toner image to be formed on the sheet and read image data of the toner image formed on the sheet and read by the image reader; and estimate a residual toner amount of the residual toner resulting from the abnormal image of the identified type.

According to Aspect 13, an image forming system includes an image forming apparatus and an information processing apparatus. The image forming apparatus forms a toner image on a sheet. The information processing apparatus is communicatively connected to the image forming apparatus. The image forming apparatus includes an image bearer, a cleaning device, an image reader, and a controller. The image bearer bears the toner image. The cleaning device collects residual toner that remains untransferred on the image bearer. The image reader reads the toner image formed on the sheet. The controller controls an operation of the image forming apparatus. The controller includes an information acquisition unit and a first estimation unit. The information acquisition unit acquires environmental information inside the image forming apparatus and sheet type information of the sheet on which the toner image is to be formed based on to-be-formed image data of the toner image to be formed on the sheet. The information processing apparatus includes an inference unit. The inference unit infers a correction parameter using a learning model from the environmental information and the sheet type information acquired by the information acquisition unit. The learning model is a model that receives, as input, the environmental information and the sheet type information acquired by the information acquisition unit and outputs the correction parameter for correcting an estimated amount of the residual toner. The estimated amount is a residual toner amount estimated from the to-be-formed image data of the toner image to be formed on the sheet. The first estimation unit identifies a type of an abnormal image, based on a difference between the to-be-formed image data of the toner image to be formed on the sheet and read image data of the toner image formed on the sheet and read by the image reader, estimates the residual toner amount of the residual toner resulting from the abnormal image of the identified type, and corrects the residual toner amount of the residual toner estimated from the to-be-formed image data, using the correction parameter inferred by the inference unit.

1. An image forming apparatus comprising:
an image bearer to bear a toner image to be formed on a sheet;
a cleaning device to collect residual toner that remains untransferred on the image bearer;
an image reader to read the toner image formed on the sheet; and
circuitry configured to control an operation of the image forming apparatus, wherein
the circuitry is configured to:
identify a type of an abnormal image, based on a difference between to-be-formed image data of the toner image to be formed on the sheet and read image data of the toner image formed on the sheet and read by the image reader; and
estimate a residual toner amount of the residual toner based on the abnormal image of the identified type.

2. The image forming apparatus according to claim 1, wherein the circuitry is configured to:
acquire environmental information indicating an environment inside the image forming apparatus and sheet type information of the sheet on which the toner image is to be formed;
infer a correction parameter using a learning model from the acquired environmental information and the acquired sheet type information, the learning model being a model that receives, as input, the acquired environmental information and the acquired sheet type information and outputs the correction parameter for correcting an estimated amount of the residual toner, the estimated amount being the residual toner amount estimated from the to-be-formed image data; and
correct the residual toner amount estimated from the to-be-formed image data, using the inferred correction parameter.

3. The image forming apparatus according to claim 2, wherein the circuitry is configured to generate the learning model that receives, as the input, the environmental information and the sheet type information and outputs the correction parameter.

4. The image forming apparatus according to claim 3, wherein the circuitry is configured to:
acquire validity information indicating whether correction for the residual toner amount is correct; and
update the learning model based on the acquired validity information.

5. The image forming apparatus according to claim 3, wherein the circuitry is further configured to use deterioration information of the image bearer as the input to train the learning model.

6. The image forming apparatus according to claim 1, wherein the circuitry is configured to estimate a toner consumption amount based on the estimated residual toner amount and the read image data of the toner image formed on the sheet and read.

7. The image forming apparatus according to claim 1, wherein the circuitry is configured to use a calculation method corresponding to the identified type of the abnormal image to estimate the residual toner amount of the residual toner resulting from the abnormal image of the identified type.

8. The image forming apparatus according to claim 1, wherein the circuitry is configured to, when the abnormal image of the identified type is a vertical streak image extending in a conveyance direction of the sheet, multiply a rotational distance of the image bearer by a width of the vertical streak image to estimate a residual toner amount of the residual toner resulting from the vertical streak image.

9. The image forming apparatus according to claim 1, wherein the circuitry is configured to, when the abnormal image of the identified type is not a vertical streak image extending in a conveyance direction of the sheet, subtract a toner amount for an image that is present only in the read image data from a value obtained by dividing the toner amount for the image that is present only in the read image data by a transfer rate to estimate the residual toner amount of the residual toner resulting from the abnormal image.

10. The image forming apparatus according to claim 1, wherein the circuitry is configured to record abnormal image management information in a memory, the abnormal image management information being information in which, for each type of the abnormal image, presence or absence of the abnormal image and the estimated residual toner amount of the residual toner resulting from the abnormal image are associated with each other.

11. An image forming method comprising:
with an image bearer, bearing a toner image to be formed on a sheet;
with a cleaning device, collecting residual toner that remains untransferred on the image bearer;
with an image reader, reading the toner image formed on the sheet;
identifying a type of an abnormal image, based on a difference between to-be-formed image data of the toner image to be formed on the sheet and read image data of the toner image formed on the sheet and read; and
estimating a residual toner amount of the residual toner based on the abnormal image of the identified type.

12. An image forming system comprising:
an image forming apparatus to form a toner image on a sheet; and
an information processing apparatus to be communicatively connected to the image forming apparatus,
the image forming apparatus including:
an image bearer to bear the toner image;
a cleaning device to collect residual toner that remains untransferred on the image bearer;
an image reader to read the toner image formed on the sheet; and
first circuitry configured to:
control an operation of the image forming apparatus; and
acquire environmental information indicating an environment inside the image forming apparatus and sheet type information of the sheet on which the toner image is to be formed,
the information processing apparatus including:
second circuitry configured to infer a correction parameter using a learning model from the acquired environmental information and the acquired sheet type information, the learning model being a model that receives, as input, the acquired environmental information and the acquired sheet type information and outputs the correction parameter for correcting an estimated amount of the residual toner, the estimated amount being a residual toner amount estimated from to-be-formed image data of the toner image to be formed on the sheet, wherein
the first circuitry is configured to:
identify a type of an abnormal image, based on a difference between the to-be-formed image data of the toner image to be formed on the sheet and read image data of the toner image formed on the sheet and read;
estimate the residual toner amount of the residual toner resulting from the abnormal image of the identified type; and
correct the residual toner amount of the residual toner estimated based on the to-be-formed image data, using the inferred correction parameter.
